(19) United States
(12) Patent Application Publication
(10) Pub. No.: US 2015/0296834 A1
(43) Pub. Date: Oct. 22, 2015

(54) PLANT BASED MEAT STRUCTURED PROTEIN PRODUCTS

(71) Applicant: Savage River, Inc. dba Beyond Meat, Inc., El Segundo, CA (US)

(72) Inventor: Timothy Geistlinger, Redondo Beach, CA (US)

(21) Appl. No.: 14/687,803

(22) Filed: Apr. 15, 2015

Related U.S. Application Data
(60) Provisional application No. 61/981,119, filed on Apr. 17, 2014.

(51) Int. Cl. A23J 3/00; A23L 1/314

(52) U.S. Cl. CPC A23J 3/04; A23L 1/31436; A23V 2002/00

(57) ABSTRACT

Provided are food products having structures, textures, and other properties similar to those of animal meat. Also provided are processes for producing such food products. The processes comprise producing the food products under alkaline conditions.

### CROSS REFERENCE TO RELATED APPLICATIONS

This application claims priority from Provisional Application Ser. No. 61/981,119 filed on Apr. 17, 2014, which is hereby incorporated by reference in its entirety.

### FIELD OF THE INVENTION

Provided are food products that have structures, textures, and other properties comparable to those of animal meat, and that may therefore serve as substitutes for animal meat. Also provided are processes for production of such meat structured protein products. The processes utilize a pH adjusting agent to achieve an alkaline pH.

### BACKGROUND OF THE INVENTION

The health and environmental benefits of vegetarian and vegan diets are broadly recognized. To meet the rising demand for vegetarian and vegan dietary products, food scientists have engaged in efforts to develop protein food products that are not derived from animals but provide similar eating experiences and nutritional benefits as animal meat. Such efforts have had limited success, however, and consumer satisfaction and acceptance rates of the new protein food products have been low.

One barrier for acceptance is that the new vegetarian/vegan protein food products do not have the widely enjoyed textural and sensory characteristics of animal meat products. At the microscopic level, animal meat consists of a complex three-dimensional network of protein fibers that provides cohesion and firmness and that traps polysaccharides, fats, flavors, and moisture. In contrast, many of the available high-protein vegetarian/vegan food products have looser and less complex protein structures (i.e., no protein fibers or limited sets of protein fibers that are aligned in only one direction and within a single plane) that disassemble easily during chewing, requiring an unsatisfactory, diminutive bite force and chewing time, and imparting sensations of “mealiness”, “rubberiness”, “sponginess”, and/or “sliminess”. Without a three-dimensional matrix, the new protein food products also cannot trap moisture and flavor effectively. The protein structures of the available vegetarian/vegan protein products also do not appear able of withstanding long hydration times under the retort conditions that are required for long-term packaging, preparation, and pasteurization of food products. Lastly, many of the currently available vegetarian/vegan protein food products comprise agents such as gluten or soy protein that cannot be consumed by an increasing number of people who are sensitive to these agents or who prefer to not consume them.

Therefore, there exists an unmet need for non-animal-derived protein products that have the structure, texture, and other properties of animal meat, and that do not challenge common nutritional sensitivities. The present invention provides such and related food products, as well as processes for their production.

### SUMMARY OF THE INVENTION

One aspect of the present invention provides meat structured protein products that have an alkaline pH of at least 7.05. The meat structured protein products comprise at least about 5% by weight of non-animal protein material, at least about 30% by weight of water, and protein fibers that are substantially aligned. In some embodiments, the meat structured protein products comprise a pH adjusting agent. In some embodiments, the meat structured protein products are gluten-free and do not comprise any cross-linking agents.

Another aspect of the present invention provides processes for producing the meat structured protein products. The process typically comprises the steps of combining a non-animal protein material and water with a pH adjusting agent to form a dough that has an alkaline pH of at least 7.05; shearing and heating the dough so as to denature the proteins in the protein material and to produce protein fibers that are substantially aligned; and setting the dough to fix the fibrous structure previously obtained.

Yet another aspect of the present invention provides extended meat products. In general, the extended meat products comprise animal meat products and meat structured protein products having an alkaline pH and comprising at least about 5% by weight of non-animal protein material, at least about 30% by weight of water, and protein fibers that are substantially aligned.

### FIGURE LEGENDS

FIG. 1 shows images of protein fibrous products as provided herein and as produced by thermoplastic extrusion from a dough that had a pH of about 6.84 (A), 7.09 (B), 7.18 (C), or 7.23 (D).

FIG. 2 shows images of ground beef (A) and hydrated protein fibrous product crumbles as provided herein and as produced by thermoplastic extrusion from a dough that had a pH of about 7.09 (B) or 7.23 (C).

FIG. 3 shows microscopic images of meat structured protein products as provided herein and as produced by thermoplastic extrusion from a dough having a pH of about 6.84 (A) or 7.32 (B through E). In panels A, B, and D, red coloring identifies H&E (Hematoxylin & Eosin)-stained protein. In panels C and E, purple coloring identifies protein, and magenta coloring identifies PAS (Periodic Acid-Schiff)-stained polysaccharides and glycolipids. In panels B through E, clear areas indicate air or water. In panel A, clear areas are due to freezing-induced fractures in the sample.

FIG. 4A shows the Warner-Bratzler shear (WBS) strengths of protein fibrous products of Example 1, including calculated correlation coefficients of WBS strengths and pH of the protein fibrous products.

FIG. 4B shows the Warner-Bratzler shear (WBS) strengths of hydrated protein fibrous products of Example 1, including calculated correlation coefficients of WBS strengths and pH of the hydrated protein fibrous products.

FIG. 4C shows the Warner-Bratzler shear (WBS) strengths of protein fibrous products of Example 2.

FIG. 4D shows the Warner-Bratzler shear (WBS) strengths of protein fibrous products of Example 2, including calculated correlation coefficients of WBS strengths and potassium bicarbonate levels in the dry mixes used in the production of the protein fibrous products.

FIG. 4E shows the Warner-Bratzler shear (WBS) strengths of hydrated protein fibrous products of Example 2.

FIG. 4F shows the Warner-Bratzler shear (WBS) strengths of hydrated protein fibrous products of Example 2, including calculated correlation coefficients of WBS strengths and potassium bicarbonate levels in the dry mixes used in the production of the hydrated protein fibrous products.

FIG. 5A shows chewiness and gumminess characteristics of cooked ground beef compared to those of hydrated protein fibrous products as determined by Texture Profile Analysis (TPA).

FIG. 5B shows hardness characteristics of cooked ground beef compared to those of hydrated protein fibrous products as determined by Texture Profile Analysis (TPA).

FIG. 5C shows cohesiveness characteristics of cooked ground beef compared to those of hydrated protein fibrous products as determined by Texture Profile Analysis (TPA).

FIG. 5D shows resilience characteristics of cooked ground beef compared to those of hydrated protein fibrous products as determined by Texture Profile Analysis (TPA).

FIG. 5E shows springiness characteristics of cooked ground beef compared to those of hydrated protein fibrous products as determined by Texture Profile Analysis (TPA).

FIG. 6 shows the moisture content (MC) of cooked ground beef compared to that of hydrated protein fibrous products provided herein, calculated in relation to wet sample.

FIG. 7A shows the water holding capacity (WHC) of hydrated protein fibrous products provided herein as a bar graph.

FIG. 7B shows the water holding capacity (WHC) of hydrated protein fibrous products as a scatter graph, including the calculated correlation coefficient of WHC and potassium bicarbonate levels in the liquid mixes used in their production.

FIG. 8A shows the water activity (WA) of protein fibrous products, including the calculated correlation coefficient of WA and potassium bicarbonate levels in the liquid mixes used in their production.

FIG. 8B shows the water activity (WA) of hydrated protein fibrous products, including the calculated correlation coefficient of WA and potassium bicarbonate levels in the liquid mixes used in their production.

FIG. 9A shows the percent dissolved solids (PDS) of cooked ground beef compared to that of hydrated protein fibrous products as a bar graph.

FIG. 9B shows the percent dissolved solids (PDS) of cooked ground beef compared to that of hydrated protein fibrous products as a scatter graph, including the calculated correlation coefficient of the PDS and potassium bicarbonate levels in the liquid mixes used in their production.

FIG. 10A shows the high heat hydration integrity (HHHI) of protein fibrous products as size before and after high heat hydration.

FIG. 10B shows the high heat hydration integrity (HHHI) of protein fibrous products percent size reduction during high heat hydration.

FIG. 11A shows the statistical correlation between amount of potassium bicarbonate in the doughs and the pH of the doughs.

FIG. 11B shows the statistical correlation between the pH of the doughs and the pH of the protein fibrous products.

FIG. 12 shows Pearson Correlation Coefficients for various attributes of protein fibrous products and hydrated protein fibrous products.

### DETAILED DESCRIPTION OF THE INVENTION

Unless defined otherwise, all technical and scientific terms used herein have the same meaning as is commonly understood by one of ordinary skill in the art to which this disclosure pertains.

### Definitions

The term “80/20 ground beef” as used herein refers to animal-derived ground beef that comprises 20% by weight of fat.

The term “animal meat” as used herein refers to flesh, whole meat muscle, or parts thereof, derived from an animal.

The term “controlled conditions” as used herein refers to conditions that are defined by a human. Examples of conditions that can be defined by a human include but are not limited to the level of oxygenation, pH, salt concentration, temperature, and nutrient (e.g., carbon, nitrogen, sulfur) availability. A plant source grown under “controlled conditions” may produce a distribution of proteins, carbohydrates, lipids, and compounds that is not native to the plant source.

The term “dough” as used herein refers to a blend of dry ingredients (“dry mix”; e.g., proteins, carbohydrates, and lipids including liquid oils) and liquid ingredients (“liquid mix”; e.g., water, and all other ingredients added with water) from which a meat structured protein product as provided herein is produced through the application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, redox).

The terms “extending”, and its passive “extended”, as used herein refer to improving the nutritional content, moisture content, or another property of a food product.

The term “extended meat product” as used herein refers to an animal meat that is extended with a meat structured protein product provided herein.

The term “high heat hydration integrity”, or its acronym “HHHI”, as used herein refers to the integrity of a sample to not fragment upon high heat hydration (i.e., hydration in water at 100° C. for 30 minutes).

The term “hydrated protein fibrous product” as used herein refers to the product obtained after a protein fibrous product has absorbed water (e.g., is hydrated or marinated).

The term “meat structured protein product” as used herein refers to a food product that is not derived from an animal but has structure, texture, and/or other properties comparable to those of animal meat. The term refers to both protein fibrous product and post-processed protein fibrous product unless otherwise indicated herein or clearly contradicted by context.

The term “modified plant source” as used herein refers to a plant source that is altered from its native state (e.g., mutated, genetically engineered).

The term “moisture content” and its acronym “MC” as used herein refer to the amount of moisture in a material as measured in an analytical method calculated as percentage change in mass following the evaporation of water from a sample.

The term “mouth feel” as used herein refers to the overall appeal of a food product, which stems from the combination of characteristics such as aroma, moistness, chewiness, bite force, degradation, and fattiness that together provide a satisfactory sensory experience.

The term “native” as used herein refers to what is natural (i.e., found in nature). For example, a protein that is native to a plant source is naturally produced by the plant source when the plant source is not intentionally modified by a human aside from growing the plant source under controlled conditions.

The term “natural” or “naturally occurring” as used herein refers to what is found in nature.

The terms “optional” or “optionally” mean that the feature or structure may or may not be present, or that an event or circumstance may or may not occur, and that the description includes instances where a particular feature or structure is present and instances where the feature or structure is absent, or instances where the event or circumstance occurs and instances where the event or circumstance does not occur.

The term “pea flour” as used herein refers to a comminuted form of defatted pea material, preferably containing less than about 1% oil, formed of particles having a size such that the particles can pass through a No. 100 mesh (U.S. Standard) screen. It typically has at least 20% protein on a dry-weight basis.

The term “pea protein” as used herein refers to protein present in pea.

The term “pea protein concentrate” as used herein refers to the protein material that is obtained from pea upon removal of soluble carbohydrate, ash, and other minor constituents. It has at least 40% protein on a dry-weight basis.

The term “pea protein isolate” as used herein refers to the protein material that is obtained from pea upon removal of insoluble polysaccharide, soluble carbohydrate, ash, and other minor constituents. It typically has at least 80% protein on a dry-weight basis.

The term “pea starch” as used herein refers to starch present in pea.

The term “pH adjusting agent” as used herein refers to an agent that raises or lowers the pH of a solution.

The term “percent dissolved solids”, and its acronym “PDS”, as used herein refer to the percentage of original solid mass that was solubilized during the hydration step of the water holding capacity assay. A method for measuring PDS is exemplified in Example 2.

The term “post-processed protein fibrous product” as used herein refers to the food product that is obtained after a protein fibrous product has undergone post-processing. The term encompasses hydrated protein fibrous product.

The term “post-processing” as used herein refers to processing the protein fibrous product undergoes after its fibrous structure is generated and fixed, including but not limited to hydration and marination.

The term “protein” as used herein refers to a polymeric form of amino acids of any length, which can include coded and non-coded amino acids, chemically or biochemically modified or derivatized amino acids, and polypeptides having modified peptide backbones.

The term “protein fiber” as used herein refers to a continuous filament of discrete length made up of protein held together by intermolecular forces such as disulfide bonds, hydrogen bonds, electrostatic bonds, hydrophobic interactions, peptide strand entanglement, and Maillard reaction chemistry creating covalent cross-links between side chains of proteins.

The term “protein fibrous product” as used herein refers to the food product obtained from a dough after application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, redox).

The term “substantially aligned” as used herein refers to an arrangement of protein fibers such that a significantly high percentage of the fibers are contiguous to each other at less than about a 45° angle when viewed in a horizontal plane. A method for analyzing protein fiber arrangements is exemplified in Example 2.

The term “Texture Profile Analysis”, and its acronym “TPA”, as used herein refer to the evaluation of mechanical characteristics of a material by subjecting the material to a controlled force from which a deformation curve of its response is generated. Mechanical characteristics determined by TPA have proven to be correlated to sensory perceptions of food products. For example, “Gumminess” is related to the energy that is required to disintegrate a food item to a state ready for swallowing; “Cohesiveness” to the strength of internal bonds making up the body of the food item; “Chewiness” to the energy required to chew a food product to a state where it is ready for swallowing; and “Hardness” to the force required to compress a food between molars. TPA is exemplified in Example 2.

The term “Warner-Bratzler shear strength” and its acronym “WBS strength” as used herein refer to the maximum force needed to mechanically shear through a sample. A method for measuring WBS is exemplified in Example 1. The WBS strength is an established measure of meat tenderness.

The term “water activity” and its acronym “WA” as used herein refer to the amount of free water in a sample. A method for measuring WA is exemplified in Example 2.

The term “water holding capacity” and its acronym “WHC” as used herein refer to the ability of a food structure to prevent water from being released from its 3-dimensional protein structure during the application of forces, pressing, centrifugation, or heating. A method for measuring WHC is exemplified in Example 2.

The terms “a” and “an” and “the” and similar referents as used herein refer to both the singular and the plural, unless otherwise indicated herein or clearly contradicted by context.

The term “about” as used herein refers to greater or lesser than the value or range of values stated by 1/10 of the stated values, but is not intended to limit any value or range of values to only this broader definition. For instance, a value of “about 30%” means a value of between 27% and 33%. Each value or range of values preceded by the term “about” is also intended to encompass the embodiment of the stated absolute value or range of values.

Recitation of ranges of values herein are merely intended to serve as a shorthand method of referring individually to each separate value inclusively falling within the range, unless otherwise indicated herein, and each separate value is incorporated into the specification as if it were individually recited herein.

### Meat Structured Protein Products

In one aspect, provided herein are meat structured protein products that have an alkaline pH. The meat structured protein products have several advantages. They have structures, textures, and other properties that resemble those of animal meat, comprise high protein, fiber, and lipid content, and are produced using only natural ingredients. They can be devoid of allergenic compounds (e.g., gluten, soy) and of substantial amounts of unhealthy saturated fats and yet provide a similar mouth feel as animal meat.

The meat structured protein products provided herein have an alkaline pH of at least 7.05. In some embodiments, the meat structured protein products have a pH of between 7.2 and about 12, between 7.2 and about 10, between 7.4 and about 10.0, between 7.6 and about 9.0, between 7.8 and about 9.0, between about 8.0 and about 9.0, or between about 8 and about 10.

The meat structured protein products provided herein may comprise a pH adjusting agent. Suitable pH adjusting agents include those that lower the pH of the dough (acidic pH adjusting agents having a pH below 7) and those that raise the pH of the dough (basic pH adjusting agents having a pH above 7). In some such embodiments, the pH of the pH adjusting agents is lower than 7, between 6.95 and about 2, between 6.95 and about 4, between about 4 and about 2, higher than 7.05, between 7.05 and about 12, between 7.05 and about 10, between 7.05 and about 8, between about 9 and about 12, or between about 10 and about 12.

The pH adjusting agent may be organic or inorganic. Examples of suitable pH adjusting agents include but are not limited to salts, ionic salts, alkali metals, alkaline earth metals, and monovalent or divalent cationic metals. Examples of suitable salts include but are not limited to hydroxides, carbonates, bicarbonates, chlorides, gluconates, acetates, or sulfides. Examples of suitable monovalent or divalent cationic metals include but are not limited to calcium, sodium, potassium, and magnesium. Examples of suitable acidic pH adjusting agents include but are not limited to acetic acid, hydrochloric acid, citric acid, succinic acid, and combinations thereof. Examples of suitable basic pH adjusting agents include but are not limited to potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. In exemplary embodiments, the pH adjusting agent is a food grade edible acid or food grade edible base.

In some embodiments, the meat structured protein products provided herein comprise between about 0.1% and about 10%, between about 0.1% and about 8%, between about 0.1% and about 6%, between about 0.1% and about 0.7%, between about 1% and about 3%, between about 1% and about 7%, between about 1% and 5%, or between about 1% and about 3% by weight potassium bicarbonate. In some embodiments, the meat structured protein products provided herein comprise between about 0.1% and about 10%, between about 0.1% and about 8%, between about 0.1% and about 6%, between about 0.1% and about 0.7%, between about 1% and about 3%, between about 1% and about 7%, between about 1% and 5%, or between about 1% and about 3% by weight sodium bicarbonate. In some embodiments, the meat structured protein products provided herein comprise between about 0.1% and about 5%, between about 0.1% and about 3%, between about 0.1% and about 2%, between about 0.1% and about 1%, between about 0.2% and about 0.5%, or between about 0.4% and about 1% by weight calcium carbonate. In some embodiments, the meat structured protein products provided herein comprise between about 0.1% and about 3%, between about 0.1% and about 2%, between about 0.1% and about 1%, between about 0.1% and about 0.5%, or between about 0.1% and about 0.25% by weight calcium hydroxide. In some embodiments, the meat structured protein products comprise between about 0.005% and about 0.1%, between about 0.005% and about 0.05%, or between about 0.005% and about 0.025% by weight of potassium hydroxide. In some embodiments, the meat structured protein products comprise between about 0.005% and about 0.1%, between about 0.005% and about 0.05%, or between about 0.005% and about 0.025% by weight of sodium hydroxide.

The meat structured protein products provided herein comprise at least about 5% by weight of protein. The protein may be comprised of polypeptide molecules having an identical amino acid sequence, or of a mixture of polypeptide molecules having at least 2 different amino acid sequences. The protein may be derived from any one plant source or from multiple plant sources, or it may be produced synthetically. In some embodiments, at least some of the protein is derived from plant. In some embodiments, the protein is not derived from a plant source but is identical or similar to protein found in a plant source, for example, the protein is synthetically or biosynthetically generated but comprises polypeptide molecules that have an identical or similar amino acid sequence as polypeptide molecules found in a plant source. In some embodiments, the protein fibrous products comprise between about 10% and about 90%, between about 20% and about 80%, between about 30% and about 70%, between about 34% and about 50%, between about 30% and about 60%, between about 30% and about 50%, between about 40% and about 50%, between about 60% and about 80%, or between about 70% and about 90% by weight of protein. In some embodiments, the hydrated protein fibrous products comprise between about 5% and about 45%, between about 10% and about 40%, between about 10% and about 25%, between about 15% and about 35%, between about 15% and about 30%, between about 15% and about 25%, between about 10% and about 25%, between about 20% and about 25%, between about 30% and about 40%, or between about 35% and about 45% by weight of protein. Protein content of a food product can be determined by a variety of methods, including but not limited to AOAC International reference methods AOAC 990.03 and AOAC 992.15. In some embodiments, the meat structured protein products comprise pea protein. The pea protein may be derived from whole pea or from a component of pea in accordance with methods generally known in the art. The pea may be standard pea (i.e., non-genetically modified pea), commoditized pea, genetically modified pea, or combinations thereof. In some embodiments, the protein fibrous products provided herein comprise between about 10% and about 90%, between about 20% and about 80%, between about 30% and about 70%, between about 40% and about 60% or between about 34% and about 46% by weight of Pisum sativum protein. In some embodiments, the hydrated protein fibrous products provided herein comprise between about 5% and about 45%, between about 10% and about 40%, between about 15% and about 35%, between about 11% and about 23%, or between about 20% and about 30% by weight of Pisum sativum protein.

The meat structured protein products provided herein can comprise lipid. Without being bound by theory, it is believed that lipid may prevent the sensation of drying during chewing. Examples of suitable lipids include but are not limited to docosahexaenoic acid, eicosapentaenoic acid, conjugated fatty acids, eicosanoids, palmitic acid, glycolipids (e.g., cerebrosides, galactolipids, glycosphingolipids, lipopolysaccharides, gangliosides), membrane lipids (e.g., ceramides, sphingomyelin, bactoprenol), glycerides, second messenger signaling lipid (e.g., diglyceride), triglycerides, prenol lipids, prostaglandins, saccharolipids, oils (e.g., non-essential oils, essential oils, almond oil, aloe vera oil, apricot kernel oil, avocado oil, baobab oil, calendula oil, canola oil, corn oil, cottonseed oil, evening primrose oil, grape oil, grape seed oil, hazelnut oil, jojoba oil, linseed oil, macademia oil, natural oils, neem oil, non-hydrogenated oils, olive oil, palm oil, partially hydrogenated oils, peanut oil, rapeseed oil, sesame oil, soybean oil, sunflower oil, synthetic oils, vegetable oil), omega-fatty acids (e.g., arachidonic acid, omega-3-fatty acids, omega-6-fatty acids, omega-7-fatty acids, omega-9-fatty acids), and phospholipids (e.g., cardiolipin, ceramide phosphocholines, ceramide phosphoethanolamines, glycerophospholipids, phasphatidic acid, phosphatidylcholine, phosphatidylethanolamine, phosphatidylinositol, phosphospingolipids, phsophatidylserine). In some embodiments, at least some of the lipid is derived from plant. The lipid may be derived from any one plant source or from multiple plant sources. In some embodiments, the lipid is not derived from a plant source but is identical or similar to lipid found in a plant source, for example, the lipid is synthetically or biosynthetically generated but is identical or similar to lipid found in a plant source. In some embodiments, the protein fibrous products provided herein comprise between about 1% and about 10%, between about 2% and about 8%, between about 2% and about 6%, between about 2% and about 5%, between about 2% and about 4%, between about 3% and about 6%, between about 3% and about 5%, between about 3% and about 4%, between about 4% and about 5%, or between about 5% and about 10% by weight of lipid. In some embodiments, the hydrated protein fibrous products provided herein comprise between about 0.5% and about 5%, between about 1% and about 4%, between about 1% and about 3%, between about 1% and about 2%, between about 1.5% and about 3%, between about 1.5% and about 2.5%, between about 1.5% and about 2%, between about 2% and about 2.5%, between about 2.5% and about 5% by weight of lipid. Lipid content of a food product can be determined by a variety of methods, including but not limited to AOAC International reference method AOAC 954.02. In some embodiments, the meat structured protein products comprise less than about 2%, less than about 1%, less than about 0.5%, less than about 0.25%, less than about 0.1%, or less than about 0.005% by weight of saturated fat.

The meat structured protein products provided herein can comprise carbohydrate. A variety of ingredients may be used as all or part of the carbohydrate, including but not limited to starch, flour, edible fiber, and combinations thereof. Examples of suitable starches include but are not limited to maltodextrin, inulin, fructo oligosaccharides, pectin, carboxymethyl cellulose, guar gum, corn starch, oat starch, potato starch, rice starch, pea starch, and wheat starch. Examples of suitable flour include but are not limited to amaranth flour, oat flour, quinoa flour, rice flour, rye flour, sorghum flour, soy flour, wheat flour, and corn flour. Examples of suitable edible fiber include but are not limited to barley bran, carrot fiber, citrus fiber, corn bran, soluble dietary fiber, insoluble dietary fiber, oat bran, pea fiber, rice bran, head husks, soy fiber, soy polysaccharide, wheat bran, and wood pulp cellulose. In some embodiments, at least some of the carbohydrate is derived from plant. The carbohydrate may be derived from any one plant source or from multiple plant sources. In some embodiments, the carbohydrate is not derived from a plant source but is identical or similar to carbohydrate found in a plant source, for example, the carbohydrate is synthetically or biosynthetically generated but comprises molecules that have an identical or similar primary structure as molecules found in a plant source. In some embodiments, the protein fibrous products provided herein comprise between about 1% and about 20%, between about 1% and about 10%, between about 2% and about 9%, between about 1% and about 5%, between about 2% and about 4%, between about 1% and about 3% or between about 5% and about 15% by weight of carbohydrate. In some embodiments, the hydrated protein fibrous products provided herein comprise between about 0.5% and about 10%, between about 0.5% and about 5%, between about 0.5% and about 2.5%, between about 0.5% and about 1.5%, between about 1% and about 3%, or between about 2.5% and about 7.5% by weight of carbohydrate.

In some embodiments, the protein fibrous products comprise between about 0.2% to about 3%, between about 1% and about 3%, or between about 2% and about 3% by weight of starch. In some embodiments, the hydrated protein fibrous products comprise between about 0.1% to about 1.5%, between about 0.5% and about 1.5%, or between about 1% and about 1.5% by weight of starch. In some embodiments, the meat structured protein products comprise pea starch. In some such embodiments, the protein fibrous products provided herein comprise between about 0.2% and about 3%, between about 1% and about 3%, or between about 2% and about 3% by weight of Pisum sativum starch. In some such embodiments, the hydrated protein fibrous products provided herein comprise between about 0.1% and about 1.5%, between about 0.5% and about 1.5%, or between about 1% and about 1.5% by weight of Pisum sativum starch. In some embodiments, the protein fibrous products comprise between about 0.1% and about 5%, between about 0.1% and about 3%, between about 0.1% and about 2%, between about 0.1% and about 1%, or between about 0.4% and about 0.6% by weight of edible fiber. In some embodiments, the hydrated protein fibrous products comprise between about 0.05% and about 2.5%, between about 0.05% and about 1.5%, between about 0.05% and about 1%, or between about 0.0.5% and about 0.5% by weight of edible fiber. In some embodiments, the meat structured protein products comprise edible pea fiber. In some such embodiments, the protein fibrous products provided herein comprise between 0.1% and about 5%, between about 0.1% and about 3%, between about 0.1% and about 2%, between about 0.1% and about 1%, or between about 0.4% and about 0.6% by weight of Pisum sativum edible fiber. In some embodiments, the hydrated protein fibrous products comprise between about 0.05% and about 2.5%, between about 0.05% and about 1.5%, between about 0.05% and about 1%, or between about 0.0.5% and about 0.5% by weight of Pisum sativum edible fiber.

The meat structured protein products provided herein comprise a moisture content (MC) of at least about 30%. A method for determining MC is exemplified in Example 2. Without being bound by theory, it is believed that a high MC may prevent the sensation of drying during chewing. In some embodiments, the protein fibrous products provided herein comprise a MC of between about 30% and about 70%, between about 40% and about 60%, between about 33% and about 45%, between about 40% and about 50% between about 30% and about 60%, between about 50% and about 70%, or between about 55% and about 65% by weight. In some embodiments, the hydrated protein fibrous products provided herein comprise a MC of between about 50% and about 85%, between about 60% and about 80%, between about 50% and about 70%, between about 70% and about 80%, between about 75% and about 85%, or between about 65% and about 90% by weight.

It is also within the scope of the invention that the meat structured protein products provided herein comprise small amounts (i.e., 2% or less by weight) of protein, carbohydrate, lipid, or other ingredients derived from animal (e.g., albumin or collagen).

The meat structured protein products provided herein have a microscopic protein structure similar to that of animal meat. Specifically, the meat structured protein products are made up of protein fibers that are substantially aligned and that form a three-dimensional protein network. Methods for determining the degree of protein fiber alignment and three-dimensional protein network are known in the art and include visual determination based upon photographs and micrographic images, as exemplified in Example 2. Without being bound by theory, it is believed that the microscopic protein structures of the meat structured protein products provided herein impart physical, textural, and sensory properties that are similar to those of cooked animal meat, wherein the aligned and interconnected protein fibers may impart cohesion and firmness, and the open spaces in the protein network may weaken the integrity of the fibrous structures and tenderize the meat structured protein products while also providing pockets for capturing water, carbohydrates, salts, lipids, flavorings, and other materials that are slowly released during chewing to lubricate the shearing process and to impart other meat-like sensory characteristics. In some embodiments, in the meat structured protein products provided herein at least about 55%, at least about 65%, at least about 75%, at least about 85%, or at least about 95% of the protein fibers are substantially aligned.

In some embodiments, the protein fibrous products provided herein have an average thick-blade WBS strength of between about 1,300 grams and about 16,500 grams, between about 5,000 grams and about 12,000 grams, between about 6,000 grams and about 10,000 grams, between about 7,000 grams and about 9,500 grams, or between about 7,500 grams and about 9,000 grams. In some embodiments, the protein fibrous products provided herein have an average thin-blade WBS strength of between about 1,100 grams and about 12,500 grams, between about 1,900 grams and about 10,500 grams, between about 2,000 and about 7,000, or between about 4,000 grams and about 6,500 grams. In some embodiments, the hydrated protein fibrous products provided herein have an average thin-blade WBS strength of less than about 1,900 grams, between about 500 grams and about 5,000 grams, between about 1,000 grams and about 4,000 grams, or between about 1,500 grams and about 3,000 grams. In some embodiments, the hydrated protein fibrous products provided herein have an average thin-blade WBS strength of less than about 1,900 grams, between about 325 grams and about 1,750 grams, or between about 750 grams and about 1,300 grams. Methods for determining thick-blade and thin-blade WBS strength are exemplified in Examples 1 and 2.

In some embodiments, the hydrated protein fibrous products provided herein have an average Chewiness as determined by Texture Profile Analysis (TPA) of between about 300 and about 16,000. Preferable, the hydrated protein fibrous products have an average Chewiness of between about 300 and about 7,000. In some embodiments, the hydrated protein fibrous products provided herein have an average Gumminess as determined by TPA of between about 400 and about 14,000. Preferable, the hydrated protein fibrous products have an average Gumminess of between about 444 and about 7,200. In some embodiments, the hydrated protein fibrous products provided herein have an average Hardness as determined by TPA of between about 685 and about 16,000. Preferable, the hydrated protein fibrous products have an average Hardness of between about 2,300 and about 12,400. In some embodiments, the hydrated protein fibrous products provided herein have an average Springiness as determined by TPA of between about 0.3 and about 1.5. In some embodiments, the hydrated protein fibrous products provided herein have an average Cohesiveness as determined by TPA of between about 0.39 and about 0.74. In some embodiments, the hydrated protein fibrous products provided herein have an average Resilience as determined by TPA of between about 0.21 and about 0.41. Methods for determining these mechanical characteristics by TPA are exemplified in Example 2.

In some embodiments, the hydrated protein fibrous products provided herein have an average water holding capacity (WHC) of between about 72% and about 86%. Preferable, the hydrated protein fibrous products have an average WHC of between about 77% and about 86%. A method for determining WHC is exemplified in Example 2.

In some embodiments, the meat structured protein products provided herein have an average water activity (WA) of between about 0.935 at 23.5° C. and about 0.850 at 25.4° C. Preferable, the protein fibrous products have an average WA of between about 0.930 at 25.1° C. and about 0.860 at 25.4° C. In some embodiments, the hydrated protein fibrous products provided herein have an average WA of between about 0.970 at 27.2° C. and about 0.951 at 27.5° C. A method for determining WA is exemplified in Example 2.

In some embodiments, the hydrated protein fibrous products provided herein have an average percent dissolved solids (PDS) of between about 0.3% and about 4.1%. A method for determining PDS is exemplified in Example 2.

In some embodiments, the hydrated protein fibrous products provided herein have an average high heat hydration integrity (HHHI) of greater than 30% relative to protein fibrous product. Preferably, the hydrated protein fibrous products have an average HHHI of greater than about 40% relative to protein fibrous product. A method for determining HHHI is exemplified in Example 2.

The meat structured protein products provided herein have eating qualities and mouth feels that are substantially similar to those of cooked animal meat. For example, meat structured protein products can have similar moisture, hardness/firmness, and overall texture compared to cooked 80/20 ground beef. The eating qualities and mouth feels of a meat structured protein product can be determined using a panel of human sensory experts, as exemplified in Example 2.

In some embodiments, the meat structured protein products provided herein are stable in urea. Methods for determining urea stability are exemplified in Example 3.

In some embodiments, the meat structured protein products provided herein are gluten-free. In some embodiments, the meat structured protein products comprise no cross-linking agent that could facilitate filament formation, including but not limited to glucomannan, beta-1,3-glucan, transglutaminase, calcium salts, and magnesium salts. In some embodiments, the meat structured protein products are vegan.

The meat structured protein products provided herein may have any shape and form. Exemplary shapes include but are not limited to crumbles, strips, slabs, steaks, cutlets, patties, nuggets, loafs, tube-like, noodle-like, chunks, poppers, and cube-shaped pieces. In some embodiments, the meat structured protein products have the shape of crumbles with dimensions of between about 2 mm and about 25 mm width, between about 2 mm and about 25 mm thickness, and between about 2 mm and about 50 mm length. In some embodiments, the meat structured protein products have the shape of strips with widths of between about 1 cm and about 8 cm and lengths of between about 5 cm and about 30 cm. In some embodiments, the meat structured protein products provided herein have the shape of slabs with widths of between about 30 mm and about 110 cm. In some embodiments, the meat structured protein products provided herein have a thickness of between about 2 mm and about 15 mm, between about 3 mm and about 12 mm, between about 4 mm and about 10 mm, or between about 5 mm and about 8 mm. In some embodiments, the meat structured protein products provided herein have the same thickness across at least about 95%, at least about 90%, at least about 80%, at least about 70%, at least about 60%, or at least about 50% of their length or width. In some embodiments, the meat structured protein products provided herein have the same thickness across no more than about 50%, no more than about 40%, no more than about 30%, no more than about 20%, or no more than about 10% of their width or length.

The meat structured protein products can be sliced, cut, ground, shredded, grated, or otherwise processed, or left unprocessed. Examples of sliced forms include but are not limited to dried meats, cured meats, and sliced lunch meats. The meat structured protein products may also be stuffed into permeable or impermeable casings to form sausages. In some embodiments, the meat structured protein products provided herein are shredded and then bound together, chunked and formed, ground and formed, or chopped and formed according in compliance with Food Standards and Labeling Policy Book (USDA, August 2005) guidelines as pertaining to animal jerky.

In some embodiments, the meat structured protein products provided herein are shaped into patties. The patties can have any shape, including but not limited to square, rectangular, circular, and non-geometric. In some embodiments, the patties are circular and have diameters of between about 80 mm and 100 mm and thicknesses of between about 4 mm and about 85 mm. Patty cohesiveness can be achieved by the addition of a binding agent. Examples of suitable binding agents include but are not limited to carob bean gum, cornstarch, dried whole eggs, dried egg whites, gum arabic, konjac flour maltodextrin, potato flakes, tapioca starch, wheat gluten, vegetable gum, carageenan, methylcellulose, and xanthan gum. A suitable binding agent can be identified by titrating different binding agents against the cohesiveness and fracturability of the patty. In some embodiments, the binding agent is carageenan. In other embodiments, the binding agent is methyl cellulose. In preferred embodiments, the binding agent is a mixture of carageenan and methylcellulose. Patty formation is exemplified in Example 4.

The meat structured protein products provided herein may be prepared for human or animal consumption. They may be cooked, partially cooked, or frozen either in uncooked, partially cooked, or cooked state. Cooking may include frying either as sautéing or as deep-frying, baking, smoking, impingement cooking, steaming, and combinations thereof. In some embodiments, the meat structured protein products are used in cooked meals, including but not limited to soups, burritos, chilis, sandwiches, lasagnes, pasta sauces, stews, kebabs, pizza toppings, and meat sticks. In some embodiments, the meat structured protein products are mixed with other protein products, including but not limited to other plant-derived products and/or animal meat.

### Process for Producing Meat Structured Protein Products

In another aspect, provided herein are methods for producing the meat structured protein products provided herein.

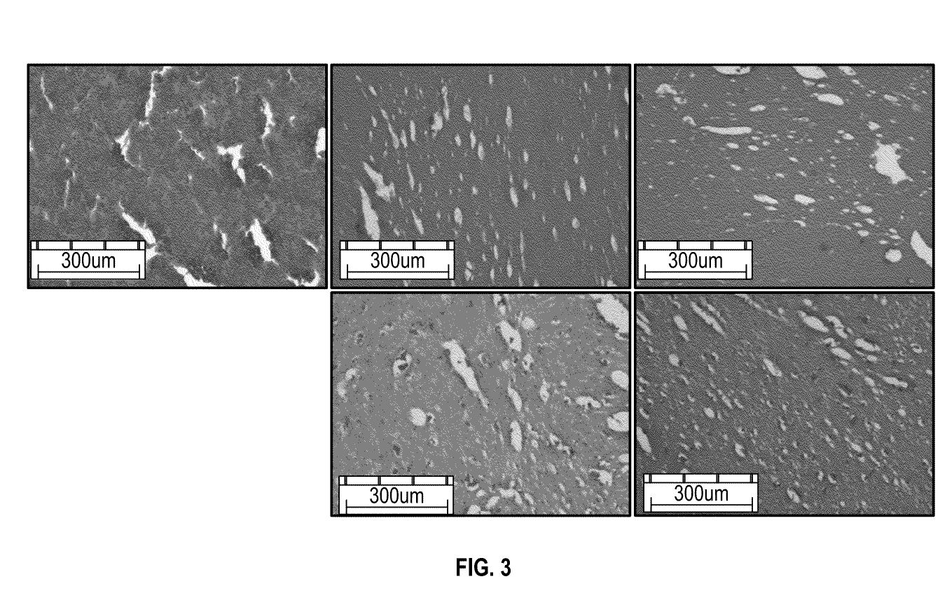

The meat structured protein products provided herein are generated by thermoplastic extrusion or other production process wherein the dough has an alkaline pH of at least 7.05. In some embodiments, the dough has a pH of between 7.05 and about 12, between 7.05 and 7.5, between 7.05 and about 8, between 7.05 and about 9, between 7.1 and 7.25, between 7.15 and 7.3, between 7.4 and about 8.2, between 7.5 and about 9, or between about 9 and about 10. It has been discovered that producing a meat structured protein product under conditions of alkaline pH results in meat structured protein products with improved animal meat-like qualities. By way of example referring to FIG. 3, the meat structured protein product depicted in FIG. 3A was prepared at pH 6.84 whereas the meat structured protein product depicted in FIGS. 3B through 3E was prepared at pH 7.32. As shown in the photographic images, the meat structured protein product produced under alkaline conditions has a consistency that is more fibrous and has more meat-like texture.

A variety of production processes may be utilized to produce the meat structured protein products provided herein. Suitable processes generally comprise three steps: (1) initial blending of liquid and dry mixes to form a dough, (2) shearing and heating to denature proteins and to produce aligned protein fibers (e.g., via application of mechanical energy [e.g., spinning, agitating, shaking, shearing, pressure, turbulence, impingement, confluence, beating, friction, wave], radiation energy [e.g., microwave, electromagnetic], thermal energy [e.g., heating, steam texturizing], enzymatic activity [e.g., transglutaminase activity], chemical reagents [e.g., pH adjusting agents, kosmotropic salts, chaotropic salts, gypsum, surfactants, emulsifiers, fatty acids, amino acids]), and (3) setting to fix the fibrous structure (e.g., via rapid temperature and/or pressure change, rapid dehydration, redox, or chemical fixation). Any of these processes may be used to produce the meat structured protein products provided herein.

Preferably, the meat structured protein products provided herein are produced by thermoplastic extrusion. Thermoplastic extrusion (also known as extrusion cooking) is a process wherein a dry mix (e.g., protein, carbohydrate, lipid) and a liquid mix (e.g., water) are fed into a closed barrel. The barrel contains one or more screw shafts that mix the mixture into a dough, convey the dough forward, and impart shear/mechanical pressure. As the dough advances along successive zones of the barrel, pressure and heat are increased, and the dough is converted into a thermoplastic melt in which proteins undergo extensive heat denaturation (causing structural changes such as breakage of hydrophobic and hydrogen bonds, hydrolysis of disulfide bonds, and formation of new covalent and non-covalent bonds). The directional shear force furthermore causes alignment of the high molecular components in the melt, leading to the formation of aligned protein fibers. When the mass is finally pushed through a cooling die, the newly generated structure is fixed in a final protein fibrous product. The protein fibrous product can be formed into any shape by using a suitable cooling die configuration, and can be cut to any size, for example by a blade chopper.

Any physiochemical parameter or extruder configuration parameter may influence the appearance, texture, and properties of the protein fibrous product. The physiochemical parameters include but are not limited to the formulation of the dough (e.g., protein type and content, carbohydrate type and content, lipid type and content, water content, other ingredients) and the cooking temperature. Configuration parameters include but are not limited to the extruder screw and barrel configuration (and resulting screw-induced shear pressure), heating profile across the heating zones, and dimensions of the cooling die. The physiochemical and configuration parameters are not mutually exclusive. Optimal physiological and configuration parameters for the thermoplastic extrusion of the meat structured protein products provided herein can be determined experimentally by titrating a particular parameter against the structure, sensory, and physical chemical characteristics (e.g., microscopic protein structure, sensory panel scores, MC, WBS, WHC, WA, mechanical characteristics, PDS, HHHI) of the end products, and identifying the setting of the parameter at which the meat structured protein products provided herein are obtained. Such titrations have provided specific physiochemical and configuration parameters suitable for the production of the meat structured protein products provided herein, as exemplified in Examples 1 and 2.

The extruder may be selected from any commercially available extruder. Suitable extruders include but are not limited to the extruders described in U.S. Pat. Nos. 4,600,311; 4,763,569; 4,118,164; and 3,117,006, which are hereby incorporated by reference in their entirety, and commercially available extruders such as the MPF 50/25 (APV Baker Inc., Grand Rapids, Mich.), BC-72 (Clextral, Inc., Tampa, Fla.), TX-57 (Wenger Manufacturing, Inc., Sabetha, Kans.), TX-168 (Wenger Manufacturing, Inc., Sabetha, Kans.), and TX-52 models (Wenger Manufacturing, Inc., Sabetha, Kans.). In some embodiments, the temperature of each successive heating zone of the extruder barrel exceeds the temperature of the previous heating zone by between about 10° C. and about 70° C. Heating can be mechanical heating (i.e., heat generated by the turning of extruder screws), electrical heating, or a combination of mechanical and electrical heating. In preferred embodiments, heating is about 10% mechanical heating and about 90% electrical heating. In preferred embodiments, the temperature of the thermoplastic melt at the point of exit from the last heating zone is between about 95° C. and about 180° C., between about 110° C. and about 165° C., between about 115° C. and about 145° C., or between about 115° C. and about 135° C. In some embodiments, the pressure in the cooling die is between about 5 psi and about 500 psi, between about 10 psi and about 300 psi, between about 30 psi and about 200 psi, between about 70 psi and about 150 psi, between about 100 psi and about 200 psi, between about 150 psi and about 300 psi, between about 200 psi and about 300 psi, between about 250 and 300 psi, or between about 300 psi and about 500 psi.

The alkaline pH of the dough may be established upon blending of the dry and liquid mixes due to the pH of the individual dry and liquid ingredients without addition of additional pH adjusting agent. Alternatively, the alkaline pH is established by the addition of a pH adjusting agent to the dough. The pH adjusting agent may be added to the dough in dry form (e.g, mixed with dry ingredients in the dry mix) or in liquid form (e.g., mixed with water of the liquid mix). Alternatively, the pH-adjusting agent may be contacted with the protein fibrous product after it has been produced, or added during post-processing.

Suitable pH adjusting agents include those that lower the pH of the dough (acidic pH adjusting agents having a pH below about 7) or those that raise the pH of the dough (basic pH adjusting agents having a pH above about 7). In some such embodiments, the pH of the pH adjusting agents is lower than 7, between 6.95 and about 2, between 6.95 and about 4, between about 4 and about 2, higher than 7.05, between 7.05 and about 12, between 7.05 and about 10, between 7.05 and about 8, between about 9 and about 12, or between about 10 and about 12. Thus, in some embodiments, the addition of the pH adjusting agent lowers the pH of the dough to between 7.05 and about 12, between 7.05 and 7.5, between 7.05 and about 8, between 7.05 and about 9, between 7.1 and 7.25, between 7.15 and 7.3, between 7.4 and about 8.2, between 7.5 and about 9, or between about 9 and about 10, and in other embodiments, the addition of the pH adjusting agent raises the pH of the dough to between 7.05 and about 12, between 7.05 and 7.5, between 7.05 and about 8, between 7.05 and about 9, between 7.1 and 7.25, between 7.15 and 7.3, between 7.4 and about 8.2, between 7.5 and about 9, or between about 9 and about 10.

The pH adjusting agent may be organic or inorganic. Examples of suitable pH adjusting agents include but are not limited to salts, ionic salts, alkali metals, alkaline earth metals, and monovalent or divalent cationic metals. Examples of suitable salts include but are not limited to hydroxides, carbonates, bicarbonates, chlorides, gluconates, acetates, or sulfides. Examples of suitable monovalent or divalent cationic metals include but are not limited to calcium, sodium, potassium, and magnesium. Examples of suitable acidic pH adjusting agents include but are not limited to acetic acid, hydrochloric acid, citric acid, succinic acid, and combinations thereof. Examples of suitable basic pH adjusting agents include but are not limited to potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. In exemplary embodiments, the pH adjusting agent is a food grade edible acid or food grade edible base.

As will be appreciated by a skilled artisan, the amount of pH adjusting agent utilized can and will vary depending upon several parameters, including, the agent selected; the desired pH; the pH of the dry and wet mixes; the type of protein, carbohydrate, lipid or other ingredient utilized; and the stage of manufacture at which the agent is added. In some embodiments, the dough comprises between about 0.1% and about 10%, between about 0.1% and about 8%, between about 0.1% and about 6%, between about 0.1% and about 0.7%, between about 1% and about 3%, between about 1% and about 7%, between about 1% and 5%, or between about 1% and about 3% by weight potassium bicarbonate. In some embodiments, the dough comprises between about 0.1% and about 10%, between about 0.1% and about 8%, between about 0.1% and about 6%, between about 0.1% and about 0.7%, between about 1% and about 3%, between about 1% and about 7%, between about 1% and 5%, or between about 1% and about 3% by weight sodium bicarbonate. In some embodiments, the dough comprises between about 0.1% and about 5%, between about 0.1% and about 3%, between about 0.1% and about 2%, between about 0.1% and about 1%, between about 0.2% and about 0.5%, or between about 0.4% and about 1% by weight calcium carbonate. In some embodiments, the dough comprises between about 0.1% and about 3%, between about 0.1% and about 2%, between about 0.1% and about 1%, between about 0.1% and about 0.5%, or between about 0.1% and about 0.25% by weight calcium hydroxide. In some embodiments, the dough comprises between about 0.005% and about 0.1%, between about 0.005% and about 0.05%, or between about 0.005% and about 0.025% by weight of potassium hydroxide. In some embodiments, the dough comprises between about 0.005% and about 0.1%, between about 0.005% and about 0.05%, or between about 0.005% and about 0.025% by weight of sodium hydroxide.

In some embodiments, the dough comprises a mixture of two or more pH adjusting agents. Such embodiments are preferred, for example, when a single pH adjusting agent has adverse effects on other attributes of the meat structured protein products, for example on taste, color, appearance, and the like. For example, a high content of potassium bicarbonate in the dough may have detrimental effects on the taste of meat structured protein products. Therefore, in some embodiments, the dough comprises potassium bicarbonate and sodium hydroxide and/or potassium hydroxide. In some such embodiments, the dough comprises between about 0.1% and about 3% by weight of potassium bicarbonate and between about 0.02% and about 0.15% by weight of sodium hydroxide or potassium hydroxide. In some embodiments, the dough comprises between 2 and 44 ppm potassium hydroxide and 2.5% potassium bicarbonate. Other methods for reducing adverse effects of the pH adjusting agent include but are not limited to preincubating the dry mix with water and the pH adjusting agent, optionally accompanied with increased mixing, heating, microwaving, or sonicating, or masking the adverse effects with other ingredients in the dough.

The dough further comprises at least about 10% by weight of protein. In some embodiments, the dough comprises between about 10% and about 90%, between about 20% and about 80%, between about 30% and about 70%, between about 34% and about 50%, between about 30% and about 60%, between about 30% and about 50%, between about 40% and about 50%, between about 60% and about 80%, or between about 70% and about 90% by weight of protein. Since the doughs provided herein ultimately result in the meat structured protein products provided herein, the same protein as described in the composition of the meat structured protein products can be utilized in making the doughs. The protein may be added to the dough in any form, including but not limited to protein concentrate, protein isolate, or protein flour; natured, denatured, or renatured protein; dried, spray dried, or not dried protein; enzymatically treated or untreated protein; and mixtures thereof. The protein added to the dough may consist of particles of any size, and may be pure or mixed with other components (e.g., other plant source components). In some embodiments, the protein is added to the dough in a preparation that has an alkaline pH. The dough typically comprises at least some protein derived from plant. In some such embodiments, the dough comprises pea protein. The pea protein may be added to the dough in the form of pea protein concentrate, pea protein isolate, pea flour, or mixtures thereof, or in any other form. In some embodiments, the dough comprises between about 10% and about 90%, between about 20% and about 80%, between about 30% and about 70%, between about 40% and about 60%, or between about 34% and about 46% by weight of Pisum sativum protein.

The dough can further comprise lipid. In some embodiments, the dough comprises between about 1% and about 10%, between about 2% and about 8%, between about 2% and about 6%, between about 2% and about 5%, between about 2% and about 4%, between about 3% and about 6%, between about 3% and about 5%, between about 3% and about 4%, between about 4% and about 5%, or between about 5% and about 10% by weight of lipid. In some embodiments, the dough comprises less than about 2%, less than about 1%, less than about 0.5%, less than about 0.25%, less than about 0.1%, or less than about 0.005% by weight of saturated fat. Since the doughs provided herein ultimately result in the meat structured protein products provided herein, the same lipid as described in the composition of the meat structured protein products can be utilized in making the doughs.

The dough can further comprise carbohydrate. In some embodiments, the dough comprises between about 1% and about 20%, between about 1% and about 10%, between about 2% and about 9%, between about 2% and about 4%, between about 1% and about 5%, between about 1% and about 3% or between about 5% and about 15% by weight of carbohydrate. In some embodiments, the dough comprises between about 0.2% to about 3% by weight of starch. In some embodiments, the dough comprises pea starch. In some such embodiments, the dough comprises between about 0.2% and about 3%, between about 1% and about 3%, or between about 2% and about 3% by weight of Pisum sativum starch. In some embodiments, the dough comprises between about 0.1% and about 5%, between about 0.1% and about 3%, between about 0.1% and about 2%, between about 0.1% and about 1%, or between about 0.4% and about 0.6% by weight of edible fiber. Since the doughs provided herein ultimately result in the meat structured protein products provided herein, the same carbohydrate as described in the composition of the meat structured protein products can be utilized in making the doughs. In some embodiments, at least some of the carbohydrate is derived from plant. In a preferred embodiment, the dough comprises at least some carbohydrate that is derived from pea.

The dough further comprises a MC of at least 30% by weight. In some embodiments, the dough comprises a MC of between about 30% and about 70%, between about 40% and about 60%, between about 33% and about 45%, between about 40% and about 50% between about 30% and about 60%, between about 50% and about 70%, or between about 55% and about 65% by weight.

In some embodiments, the dough comprises 5% or less by weight of one or more ingredients derived from animal. Without being bound by theory, it is believed that such small amount of an animal ingredient may improve the texture, color, aroma, or taste of certain embodiments of the meat structured protein products provided herein. Examples of suitable animal ingredients include but are not limited to animal meat and components thereof, including interstitial fluid extracted from animal meat.

### Other Ingredients

The doughs, meat structured protein products, and extended meat products provided herein may comprise various other ingredients. In most embodiments, the doughs, meat structured protein products, or extended meat products provided herein comprise any one of these other ingredients at between about 0.01% and about 5% by weight.

Examples of such ingredients include but are not limited to amino acids and amino acid derivatives (e.g., 1-aminocyclopropane-1-carboxylic acid, 2-aminoisobutyric acid, alanine, arginine, aspartic acid, canavanine, catecholamine, citruline, cysteine, essential amino acids, glutamate, glutamic acid, glutamine, glycine, histidine, homocysteine, hydroxyproline, hypusine, isoleucine, lanthionine, leucine, lysine, lysinoalanine, methionine, mimosine, non-essential amino acids, ornithine, phenylalanine, phenylpropanoids, photoleucine, photomethionine, photoreactive amino acids, proline, pyrrolysine, selenocysteine, serine, threonine, tryptophan, tyrosine, valine), anti-inflammatory agents (e.g., leukotriene antagonists, lipoxins, resolvins), antibiotics (e.g., alamethicin, erythromycin, tetracyclines), antimicrobial agents (e.g., potassium sorbate), antiparasitic agents (e.g., avermectins), buffering agents (e.g., citrate), clotting agents (e.g., thromboxane), coagulants (e.g., fumarate), coenzymes (e.g., coenzyme A, coenzyme C, s-adnosyl-methionine, vitamin derivatives), crosslinking agents (e.g., beta 1,3 glucan transglutaminase, calcium salts, magnesium salts), dairy protein (e.g., casein, whey protein), dietary minerals (e.g., ammonium, calcium, fat soluble minerals, gypsum, iron, magnesium, potassium, aluminum), disaccharides (e.g., lactose, maltose, trehalose), edulcorants (e.g., artifical sweeteners, corn sweeteners, sugars), egg protein (e.g., ovalbumin, ovoglobulin, ovomucin, ovomucoid, ovotransferrin, ovovitella, ovovitellin, albumin globulin, vitellin), elasticizing agents (e.g., gluten), emulsifiers (e.g., lecithin, lecithins), enzymes (e.g., hydrolase, oxidoreductase, peroxidase), essential nutrients (e.g., alpha-linolenic acid, gamma-linolenic acid, linoleic acid, calcium, iron, omega-3 fatty acids, zinc), fat soluble compounds, flavones (e.g., apigenin, chrysin, luteolin, flavonols, daemfero, datiscetin, myricetin), glycoproteins, gums (e.g., carob bean gum, guar gum, tragacanth gum, xanthan gum), hemoproteins (e.g., hemoglobin, leghemoglobin, myoglobin), humectants (e.g., polyethylene glycol, propylene glycol, sorbitol, xylitol), isoprenes, isoprenoid pathway compounds (e.g., mevalonic acid, dimethylallyl pyrophosphate, isopentenyl pyrophosphate), isoprenoids or isoprenoid derivatives (e.g., dolichols, polyprenols), liver X receptor (LXR) agonists and antagonists, meat proteins (e.g., collagen), mechanically separated meat, metabolic pathway intermediates (e.g., oxaloacetate, succinyl-CoA), monosaccharides (e.g., fructose, galactose, glucose, lactose, lyxose, maltose, manose, ribose, ribulose, xylulose), neuroactive compounds (e.g., anandamide, cannabinoids, cortisol, endocannabinoids, gammaaminobutyric acid, inositol), neutraceuticals, nucleic acids (e.g., DNA, RNA, rRNA, tRNA), nutritional supplements (e.g., carnitine, fumarate, glucosamine), oil-soluble compounds, organ meat, oxidizing agents (e.g., quinones), partially defatted tissue and blood serum proteins, plasticizing materials, polyols (e.g., alklyne glycols, butanediols, glycerine, glycerol, glycerol, mannitol, propylene glycol, sorbitol, xylitol), polysaccharides (e.g., pectin, maltodextrin, glycogen, inulin), porphyrins, secondary metabolites (e.g., polyketides), secosteroids, spices, steroids (e.g., C18-carbon containing steroids, C19-carbon containing steroids, C21-carbon containing steroids, cholesterol, cycloartenol, estradiol, lanosterol, squalene), sterols (e.g., betasitosterol, bras sicasterol, cholesterol, ergosterol, lanosterol, oxysterols, phytosterols, stigmasterol), tannins (e.g., ellagic tannins, ellagic tannins from roasted oak wood, gallic tannins, proanthocyanidin tannins from aromatic grape skin, proanthocyanidin tannins from grape seeds, proanthocyanidin tannins from grape skin, profisetinidin tannins, tannins from green tea leaves, tannins from sangre de drago), terpenes (e.g., diterpenes, monoterpenes, sesquiterpene, squalane, tetraterpenes, triterpenes), thickening agents (e.g., guar gum, pectin, xantham gum, agar, alginic acid and its salts, carboxymethyl cellulose, carrageenan and its salts, gums, modified starches, pectins, processed Eucheuma seaweed, sodium carboxymethyl cellulose, tara gum), vitamins (e.g., alpha-tocopherol, alpha-tocotrienol, beta-tocopherol, beta-tocotrienol, delta-tocopherol, deltatocotrienols, fat soluble vitamins, gamma-tocopherol, gamma-tocotrienol, pantothenic acid, vitamin A, vitamin B-12, vitamin B-12, vitamin C, vitamin D, vitamin E, vitamin E, vitamin K, water soluble vitamins), water-soluble compounds, wax esters, and xenoestrogens (e.g., phytoestrogens).

Further examples include but are not limited to antioxidants (e.g., carotenes, ubiquinone, resveratrol, alpha-tocopherol, lutein, zeaxanthin, “2,4-(tris-3′,5′-bitert-butyl-4′-hydroxybenzyl)-mesitylene (i.e., Ionox 330)”, “2,4,5-trihydroxybutyrophenone”, “2,6-di-tert-butyiphenol”, “2,6-di-tert-butyl-4-hydroxymethylphenol (i.e., Ionox 100)”, “3,4-dihydroxybenzoic acid”, 5-methoxy tryptamine, “6-ethoxy 1,2-dihydro-2,2,4-trimethylquinoline”, acetyl gallate, alpha-carotene, alpha-hydroxybenzyl phosphinic acid, alphaketoglutarate, anoxomer, ascorbic acid and its salts, ascorbyl palmitate, ascorbyl stearate, benzyl isothiocyanate, beta naphthoflavone, beta-apo-carotenoic acid, beta-carotene, beta-carotene, butylated hydroxyanisole (BHA), butylated hydroxytoluene (BHT), caffeic acid, canthaxantin, carnosol, carvacrol, catalase, catechins, chlorogenic acid, citric acid and its salts, clove extract, coffee bean extract, di-stearyl thiodipropionate, dilauryl thiodipropionate, dodecyl gallate, edetic acid, ellagic acid, erythorbic acid, esculetin, esculin, ethyl gallate, ethyl maltol, ethylenediaminetetraacetic acid (EDTA), eucalyptus extract, eugenol, ferulic acid, flavanones, flavones, flavonoids, flavonoids, flavonols, fraxetin, fumaric acid, gallic acid, gentian extract, gluconic acid, glycine, gum guaiacum, hesperetin, hydroquinone, hydroxycinammic acid, hydroxyglutaric acid, hydroxytryrosol, hydroxyurea, isflavones, lactic acid and its salts, lecithin, lecithin citrate; R-alpha-lipoic acid, lutein, lycopene, malic acid, maltol, methyl gallate, mono isopropyl citrate, monoglyceride citrate, morin, N-acetylcysteine, N-hydroxysuccinic acid, “N,N′diphenyl-p phenylenediamine (DPPD)”, natural antioxidantss, nordihydroguaiaretic acid (NDGA), octyl gallate, oxalic acid, p-coumaric acid, palmityl citrate, phenothiazine, phosphates, phosphatidylcholine, phosphoric acid, phytic acid, phytylubichromel, pimento extract, polyphosphates, propyl gallate, quercetin, retinyl palmitate, rice bran extract, rosemary extract, rosmarinic acid, sage extract, sesamol, silymarin, sinapic acid, sodium erythorbate, stearyl citrate, succinic acid, superoxide dismutase (SOD), synthetic antioxidantss, syringic acid, tartaric acid, taurine, tertiary butyl hydroquinone (TBHO), thiodipropionic acid, thymol, tocopherols, tocotrienols, trans resveratrol, trihydroxy butyrophenone, tryptamine, tyramine, tyrosol, ubiquinone, uric acid, vanillic acid, vitamin K and derivates, wheat germ oil, zeaxanthin).

Further examples include but are not limited to coloring agents (e.g., FD&C (Food Drug & cosmetics) Red Nos. 14 (erythrosine), FD&C Red Nos. 17 (allura red), FD&C Red Nos. 3 (carmosine), FD&C Red Nos. 4 (fast red E), FD&C Red Nos. 40 (allura red AC), FD&C Red Nos. 7 (ponceau 4R), FD&C Red Nos. 9 (amaranth), FD&C Yellow Nos. 13 (quinoline yellow), FD&C Yellow Nos. 5 (tartazine), FD&C Yellow Nos. 6 (sunset yellow), artificial colorants, natural colorants, titanium oxide, annatto, anthocyanins, beet juice, beta-APE 8 carotenal, beta-carotene, black currant, burnt sugar, canthaxanthin, caramel, carmine/carminic acid, cochineal extract, curcumin, lutein, mixed carotenoids, monascus, paprika, red cabbage juice, riboflavin, saffron, titanium dioxide, turmeric).

Further examples include but are not limited to flavor enhancers and flavoring agents (e.g., 5′-ribonucleotide salts, glumatic acid salts, glycine salts, guanylic acid salts, hydrolyzed proteins, hydrolyzed vegetable proteins, insomniac acid salts, monosodium glutamate, sodium chloride, galacto-oligosaccharides, sorbitol, animal meat flavor, animal meat oil, artificial flavoring agents, aspartamine, fumarate, garlic flavor, herb flavor, malate, natural flavoring agents, natural smoke extract, natural smoke solution, onion flavor, shiitake extract, spice extract, spice oil, sugars, yeast extract).

The ingredients can be native to one or more plant sources; produced by one or more modified plant sources; produced by one or more plant sources or modified plant sources under controlled conditions (e.g., aerobic conditions, anaerobic conditions, pH changes, salt conditions, temperature changes, nutrient [e.g., carbon, nitrogen, sulfur] limitations), or produced synthetically.

### Plant Source/Modified Plant Source

The protein, lipid, carbohydrate, or other ingredient of the meat structured protein products provided herein may be derived from one or more plant or modified plant sources.

Examples of suitable plants include but are not limited to spermatophytes (spermatophyta), acrogymnospermae, angiosperms (magnoliophyta), ginkgoidae, pinidae, mesangiospermae, cycads, Ginkgo, conifers, gnetophytes, ginkgo biloba, cypress, junipers, thuja, cedarwood, pines, angelica, caraway, coriander, cumin, fennel, parsley, dill, dandelion, helichrysum, marigold, mugwort, safflower, camomile, lettuce, wormwood, calendula, citronella, sages, thyme, chia seed, mustard, olive, coffee, capsicum, eggplant, paprika, cranberry, kiwi, vegetable plants (e.g., carrot, celery), tagetes, tansy, tarragon, sunflower, wintergreen, basil, hyssop, lavender, lemon verbena, marjoram, melissa, patchouli, pennyroyoal, peppermint, rosemary, sesame, spearmint, primroses, samara, pepper, pimento, potato, sweet potato, tomato, blueberry, nightshades, petunia, morning glory, lilac, jasmin, honeysuckle, snapdragon, psyllium, wormseed, buckwheat, amaranth, chard, quinoa, spinach, rhubarb, jojoba, cypselea, chlorella, manila, hazelnut, canola, kale, bok choy, rutabaga, frankincense, myrrh, elemi, hemp, pumpkin, squash, curcurbit, manioc, dalbergia, legume plants (e.g., alfalfa, lentils, beans, clovers, peas, fava coceira, frijole bola roja, frijole negro, lespedeza, licorice, lupin, mesquite, carob, soybean, peanut, tamarind, wisteria, cassia, chickpea, garbanzo, fenugreek, green pea, yellow pea, snow pea, yellow pea, lima bean, fava bean), geranium, flax, pomegranate, cotton, okra, neem, fig, mulberry, clove, eucalyptus, tea tree, niaouli, fruiting plants (e.g, apple, apricot, peach, plum, pear, nectarine), strawberry, blackberry, raspberry, cherry, prune, rose, tangerine, citrus (e.g., grapefruit, lemon, lime, orange, bitter orange, mandarin), mango, citrus bergamot, buchu, grape, broccoli, brussels, sprout, camelina, cauliflower, rape, rapeseed (canola), turnip, cabbage, cucumber, watermelon, honeydew melon, zucchini, birch, walnut, cassava, baobab, allspice, almond, breadfruit, sandalwood, macadamia, taro, tuberose, aloe vera, garlic, onion, shallot, vanilla, yucca, vetiver, galangal, barley, corn, curcuma aromatica, galangal, ginger, lemon grass, oat, palm, pineapple, rice, rye, sorghum, triticale, turmeric, yam, bamboo, barley, cajuput, canna, cardamom, maize, oat, wheat, cinnamon, sassafras, lindera benzoin, bay laurel, avocado, ylang-ylang, mace, nutmeg, moringa, horsetail, oregano, cilantro, chervil, chive, aggregate fruits, grain plants, herbal plants, leafy vegetables, non-grain legume plants, nut plants, succulent plants, land plants, water plants, delbergia, millets, drupes, schizocarps, flowering plants, non-flowering plants, cultured plants, wild plants, trees, shrubs, flowers, grasses, herbaceous plants, brushes, lianas, cacti, green algae, tropical plants, subtropical plants, temperate plants, and derivatives and crosses thereof.

Plant sources may be obtained from a variety of sources including but not limited to nature (e.g., lakes, oceans, soils, rocks, gardens, forests, plants, animals) and commercial cell banks (e.g., ATCC, collaborative sources).

Modified plant sources may be obtained from a variety of sources including but not limited to commercial cell banks (e.g., ATCC, collaborative sources), or can be generated from natural plants by methods known in the art, including selection, mutation, or gene manipulation. Selection generally involves continuous multiplication and steady increase in dilution rates under selective pressure. Mutation generally involves selection after exposure to mutagenic agents. Gene manipulation generally involves genetic engineering (e.g., gene splicing, insertion of deletions or modifications by homologous recombination) of target genes. A modified plant source may produce a non-native protein, carbohydrate, lipid, or other compound, or produce a non-native amount of a native protein, carbohydrate, lipid, or other compound. In some embodiments, the modified plant source expresses higher or lower levels of a native protein or metabolic pathway compound. In other such embodiments, the modified plant source expresses one or more novel recombinant proteins, RNAs, or metabolic pathway components derived from another plant, algae, microbe, or fungus. In other embodiments, the modified plant source has an increased nutraceutical content compared to its native state. In yet other embodiments, the modified plant source has more favorable growth and production characteristics compared to its native state. In some such embodiments, the modified plant source has an increased specific growth rate compared to its native state. In other such embodiments, the modified plant source can utilize a different carbon source than its native state.

### Post-Processing

The protein fibrous products provided herein can be further processed. Post-processing may involve but is not limited to vacuum tumbling, marinating, dehydrating, hydrating, flavoring, tenderizing, injecting, grilling, boiling in vinegar, contacting with a pH adjusting agent, coloring, or combinations thereof performed either together or in sequence.

Dehydrating can involve water loss of between about 30% and about 90% by weight compared to the protein fibrous product. In some embodiments, dehydrating produces a meat structured protein product that comprises less than about 40% by weight of water. In some embodiments, dehydrating results in a meat structured protein product that comprises less than about 5% by weight of water.

Hydrating or marinating can involve water uptake of up to about 95% by weight. In some embodiments, marinating involves a loss in MC of between about 0.5% and about 10% by weight compared to the protein fibrous product. In some embodiments, hydrating comprises the steps of mixing the protein fibrous product with a lesser, equal, or greater part by weight of water and simmering the mixture in a covered vessel while stirring. In other embodiments, hydrating comprises the step of injecting water into the protein fibrous product using a splitjack needle injector gun. In some embodiments, marinating comprises the step of mixing the protein fibrous product with a lesser, equal, or greater part by weight of water comprising flavoring, and then vacuum tumbling the mixture in a vacuum tumbler. Hydrating and marinating methods are exemplified in Examples 1 and 2.

In some embodiments, post-processing involves coagulating the meat structured protein products provided herein using a binding matrix (e.g., to obtain food products that resemble animal meat-derived bacon, burger patties, sausage links, or sausage patties).

In some embodiments, post-processing involves mixing with 5% or less by weight of one or more ingredients derived from animal. Without being bound by theory, it is believed that such small amount of an animal ingredient may improve the coagulation, color, aroma, or taste of certain embodiments of the meat structured protein products provided herein. Examples of such ingredients include but are not limited to animal meat and components thereof, including interstitial fluid extracted from animal meat.

### Process for Producing Extended Meat Products

It is also within the scope of the present invention that the extended meat products provided herein are produced by extending animal meat products with meat structured protein products as provided herein.

Examples of animal meat products that may be extended with meat structured protein products provided herein include but are not limited to meat obtained from cattle, pork, lamb, mutton, horse, goat, poultry (e.g., chicken, duck, goose, turkey), fowl (any bird species), fresh or salt water fish (e.g., catfish, tuna, sturgeon, salmon, bass, muskie, pike, bowfin, gar, paddlefish, bream, carp, trout, walleye, snakehead, and crappie), shellfish, crustaceans, game animals (e.g., buffalo, deer, elk, moose, reindeer, caribou, antelope, rabbit, bear, squirrel, beaver, muskrat, opossum, raccoon, armadillo, porcupine), and reptiles (e.g., snakes, turtles, lizards). The meat may be intact, in chunks, in steak form, ground, finely textured, trim or residues derived from processing frozen animals, low temperature rendered, mechanically separated or deboned (MDM, which is a meat paste that is recovered from animal bones, and a comminuted product that is devoid of the natural fibrous texture found in intact muscles) (i.e., meat removed from bone by various mechanical means), cooked, or combinations thereof. The meat may include muscle, skin, fat (including rendered fat such as lard and tallow, flavor enhanced animal fats, fractionated or further processed animal fat tissue), or other animal components.

Animal meat products may be extended by blending with meat structured protein products as provided herein before or after other post-processing, optionally together with other constituents, including but not limited to dietary fiber, animal or plant lipid, or animal-derived protein material (e.g. casein, caseinates, whey protein, milk protein concentrate, milk protein isolate, ovalbumin, ovoglobulin, ovomucin, ovomucoid, ovotransferrin, ovovitella, ovovitellin, albumin globulin, and vitellin). Preferably, the blended meat structured protein product and the animal meat have similar particle sizes. The amount of meat structured protein product in relation to the amount of animal meat during blending will vary depending on the intended use of the extended meat product. By way of example, when a significantly vegetarian composition that has a relatively small degree of animal flavor is desired, the concentration of animal meat in final product may be about 45%, about 40%, about 35%, about 30%, about 25%, about 20%, about 15%, or about 10% by weight. Alternatively, when a meat analog composition having a relatively high degree of animal meat flavor is desired, the concentration of animal meat may be about 50%, about 55%, about 60%, about 65%, about 70%, or about 75% by weight. Depending upon the intended use of the extended meat product, the animal meat is typically precooked to partially dehydrate the flesh and to prevent the release of fluids during further processing applications (e.g., such as retort cooking), to remove natural liquids or oils that may have strong flavors, to coagulate the animal protein and loosen the meat from the skeleton, or to develop desirable and textural flavor properties. The precooking process may be carried out in steam, water, oil, hot air, smoke, or a combination thereof. The animal meat is generally heated until the internal temperature is between about 60° C. and about 85′C.

### Packaging and Labeling

The meat structured protein products provided herein may be packaged to keep the meat structured protein products clean, fresh, contained, or safe; to facilitate inventory control, handling, distribution, stacking, display, sale, opening, reclosing, use, or reuse; or to enable portion control. Suitable packing includes but is not limited to trays, trays with overwrap, bags, cups, films, jars, tubs, bottles, pads, bowls, platters, boxes, cans, cartons, pallets, wrappers, containers, bags-in-boxes, tubes, capsules, vacuum packaging, pouches, and the like, and combinations thereof. The packaging can be made of plastic, paper, metal, glass, paperboard, polyproylene, PET, styrofoam, aluminum, or combinations thereof.

The packaging may carry one or more labels that communicate information to the consumer or that support the marketing of the meat structured protein product. In some embodiments, the packaging carries a label required by governmental regulation. In some such embodiments, the label is required by regulation of the U.S. Food and Drug Administration (FDA) or the U.S. Department of Agriculture. In other such embodiments, the label is required by regulation of the European Food Safety Authority. In some embodiments, the governmental regulation is Title 21 of the FDA section of the code of federal regulations. In some embodiments, the label indicates that the enclosed meat structured protein product is free of genetically modified organisms. In some embodiments, the label indicates that the enclosed meat structured protein product is free of gluten. In some embodiments, the label indicates that the enclosed meat structured protein product is Kosher. In some embodiments, the label indicates that the enclosed meat structured protein product is free of cholesterol. In some embodiments, the label indicates that the enclosed meat structured protein product is vegan. In some embodiments, the label indicates that the enclosed meat structured protein product is free of an allergen. In some embodiments, the label indicates that the enclosed meat structured protein product is free of soy. In some embodiments, the label indicates that the enclosed meat structured protein product is free of nuts.

### Marketing and Sale

The meat structured protein products provided herein can be sold in any suitable venue. Such venues include but are not limited to internet, grocery stores, supermarkets, discounters, mass marketers (e.g., Target, Wal-Mart), membership warehouses (e.g., Costco, Sam's Club), military outlets, drug stores, restaurants, fast food restaurants, delis, markets, butcher shops, health food stores, organic food stores, private caterers, commercial caterers, food trucks, restaurant chains, kiosks, street carts, street vendors, cafeterias (e.g., school cafeterias, hospital cafeterias), and the like.

All references, including publications, patent applications, and patents, cited herein are hereby incorporated by reference to the same extent as if each reference were individually and specifically indicated to be incorporated by reference and/or were set forth in its entirety herein.

### EXAMPLES

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### Example 1

### Production of Meat Structured Protein Products by Thermoplastic Extrusion, and Characterization by pH Measurement and Warner-Bratzler Shear (WBS) Analysis

For each product, a mix of the dry ingredients listed in Table 1 was blended for 5 minutes in a ribbon blender. The dry mix was transferred to the hopper of a gravimetric feeder that metered the blend through the feed port of a twin screw extruder (MPF 50/25 Co-rotating Twin-Screw Extruder (APV Baker, Grand Rapids, Mich.)) at a flow rate of 31 kg/hr. At the same time, a liquid mix (97% water, 3% sorbitol) was pumped through a liquid feed port located 330 mm downstream of the dry mix feed port at a flow rate of 21.65 kg/h (22.5 kg/h for the 0% and 1.25% and 1% K-bicarbonate products). The twin screw extruder mixed the dry and liquid mixes to generate dough compositions.

TABLE 1
Dry Mix Composition (% by weight)

| | Pea | | | K- | Ca- |
|---|---|---|---|---|---|
| | Protein | Gyp- | Beef | Bicar- | Hydrox- |
| Product | Isolate | sum | Flavor | bonate | ide |
| 0% K-Bicarbonate | 93.5 * | 4 | 2.5 | 0 | 0 |
| 0.5% Ca-Hydroxide | 93 * | 4 | 2.5 | 0 | 0.5 |
| 1% K-Bicarbonate | 92.5 ** | 4 | 2.5 | 1 | 0 |
| 1.25% K-Bicarbonate | 92.25 ** | 4 | 2.5 | 1.25 | 0 |
| 1.28% K-Bicarbonate | 92.22 * | 4 | 2.5 | 1.28 | 0 |
| 2.5% K-Bicarbonate | 91 * | 4 | 2.5 | 2.5 | 0 |
| 3.31% K-Bicarbonate | 90.19 * | 4 | 2.5 | 3.3 | 0 |
| 5% K-Bicarbonate | 88.5 * | 4 | 2.5 | 5 | 0 |
| 7.5% K-Bicarbonate | 86 * | 4 | 2.5 | 7.5 | 0 |
| 10% K-Bicarbonate | 83.5 * | 4 | 2.5 | 10 | 0 |

* Pea protein isolate (F85M) was obtained from Roquette, Inc., Lestrem, France, having a composition of 80% protein, 6% fat, 3% carbohydrate, 1% dietary fiber, 4% ash, and 7% water.
** Low-sodium pea protein isolate was obtained from Roquette, Inc., Lestrem, France, having a composition of 78% protein, 9% fat, 1% carbohydrate, 1% dietary fiber, 4% ash, and 7% water.
Gypsum (Calcium Sulfate, Dihydrate, Terra Alba) was obtained from CGC, Inc. Chicago, IL, having a composition of 80.0% ash (23,000 mg calcium/100 g) and 20.0% water.
Beef Flavor (NO-280-952-1) was obtained from Givaudan, Vernier, Switzerland, having a composition of 26.0% protein, 4.0% fat, 36.0% carbohydrates, 29.0% ash (8,300 mg sodium/100 g), and 5.0% water.
Potassium bicarbonate was obtained from Flow K; Church & Dwight Co., Inc. (Ewing, NJ), having a composition of 69.0% ash (39,060 mg potassium/100 g) and 31% water.
Calcium hydroxide was obtained from Mississippi Lime, St. Louis, MO.

Extrusion parameters are shown in Table 2.

TABLE 2
Extrusion Parameters

| | |
|---|---|
| Screw Profile | Zones 1-3: conveying screw elements; Zones 4, 5: |
| Assembly | mixing screw elements; Zones 6-8: medium shear |
| | screws; Zone 9: final mixing screws. |
| Extruder Barrel | 9 zones, each individually controlled via an |
| | electric heater cartridge (4 × 900 W per zone) and |
| | a cooling water jacket (supplied with building |
| | water, 60° F.); overall barrel length = 1,250 mm; |
| | length of each zone = 125 mm. |
| Barrel Heater Set | Zones 1-3: 30-35° C.; Zones 4-6: 50-85° C.; |
| Points | Zones 7-9: 100-130° C. |
| Extrusion Screws | Co-rotating in counter-clockwise direction at |
| | 300 revolutions per minute. |
| Barrel Pressure | 60-70 psi for all products except 1.25% |
| | K-Bicarb product which was at 122 psi. |
| Product Temperature | 107-113° C. |

Protein fibrous products emerged from the extruder as short, somewhat irregular, strands of crumbles or as cylindrical products. The composition of the pH adjusting agent comprising protein fibrous products was between 40% and 44% by weight of protein, between 3.24% and 3.41% by weight of carbohydrate (between 0.51% and 0.56% by weight of edible fiber), between 3.01% and 3.34% by weight of lipid, and between 44% and 45% by weight of water.

To obtain hydrated protein fibrous products, 227 g of each protein fibrous product were combined with a boiling mixture of 350 g of water, 64 g of canola oil, and 16 g of palm oil. The blend was simmered in a covered vessel for about 30 minutes before the remaining oil/water was decanted out.

### Measurement of Product pH

Samples of protein fibrous products or hydrated protein fibrous products were incubated at 77° F. A pH spear (OAKTON WD-35634-40 PH Spear, H₂O Proof, −1.0 to 15, 1-3 pt; OAKTON Instruments, Vernon Hills, Ill.) was inserted into the sample until the entire electrode tip was surrounded by sample (˜3 mm), and allowed to equilibrate for 1 min before the pH was recorded. The average pH was calculated from 3 independent readings. The electrode tip was rinsed with deionized water between readings, and recalibrated to pH standards 4/7/10 every hour to mitigate drift. The pH of select samples was also measured using a benchtop pH meter calibrated with pH standards 2/7/10. About 20 g of each product was homogenized in 75 g of water using a blender, and the mixture was set aside for 5 minutes. The electrode was placed in solution and allowed to equilibrate for 1 minute before the pH was recorded. As shown in Table 3, good correlations were observed between the amount of basic pH adjusting agent (potassium bicarbonate or calcium hydroxide) in the dough and the pH of the protein fibrous products and hydrated protein fibrous products.

TABLE 3
pH of Protein Fibrous Products and
Hydrated Protein Fibrous Products

| Product | Hydrated | pH (benchtop) | pH (spear) |
|---|---|---|---|
| 0% K-Bicarbonate | No | not determined | 6.68 |
| | Yes | not determined | 6.69 |
| 0.5% Ca-Hydroxide | No | 8.13 | 7.66 |
| | Yes | 8.6 | 7.5 |
| 1% K-Bicarbonate | No | 7.44 | 7.45 |
| | Yes | 7.38 | 7.47 |
| 1.28% K-Bicarbonate | No | not determined | 7.86 |
| | Yes | not determined | 7.54 |
| 2.5% K-Bicarbonate | No | 8.7 | 8.63 |
| | Yes | 8.54 | 8.57 |
| 3.31% K-Bicarbonate | No | not determined | 8.79 |
| | Yes | not determined | 8.82 |
| 5% K-Bicarbonate | No | 9.1 | 8.93 |
| | Yes | 9.3 | 9.44 |
| 7.5% K-Bicarbonate | No | 9.29 | 9.25 |
| | Yes | 9.59 | 9.65 |
| 10% K-Bicarbonate | No | 9.51 | 9.47 |
| | Yes | 9.86 | 9.78 |

### Warner-Bratzler Shear (WBS) Strength Analysis

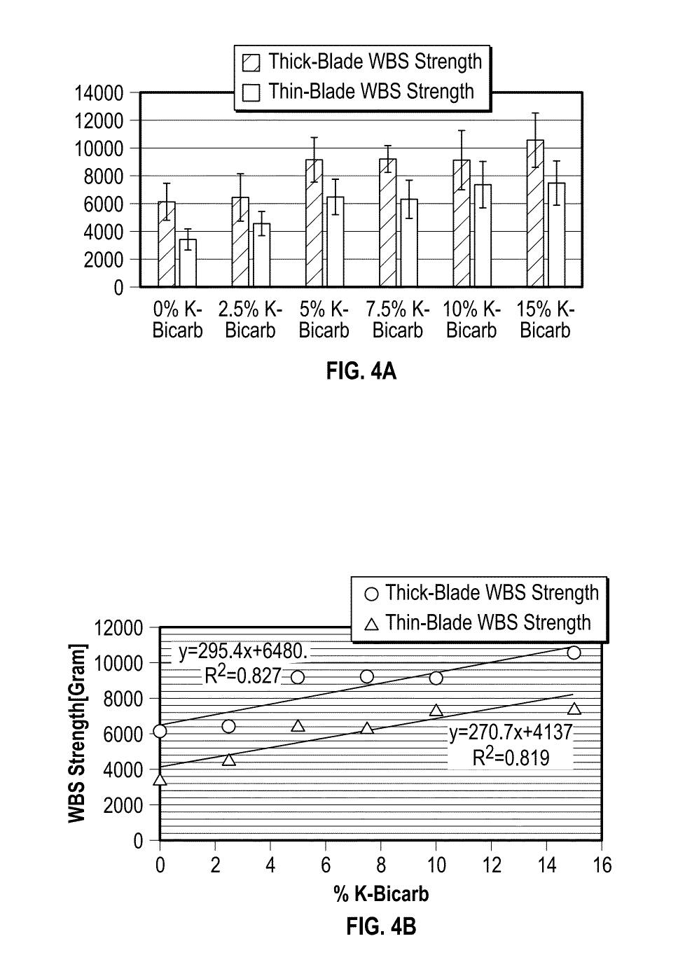

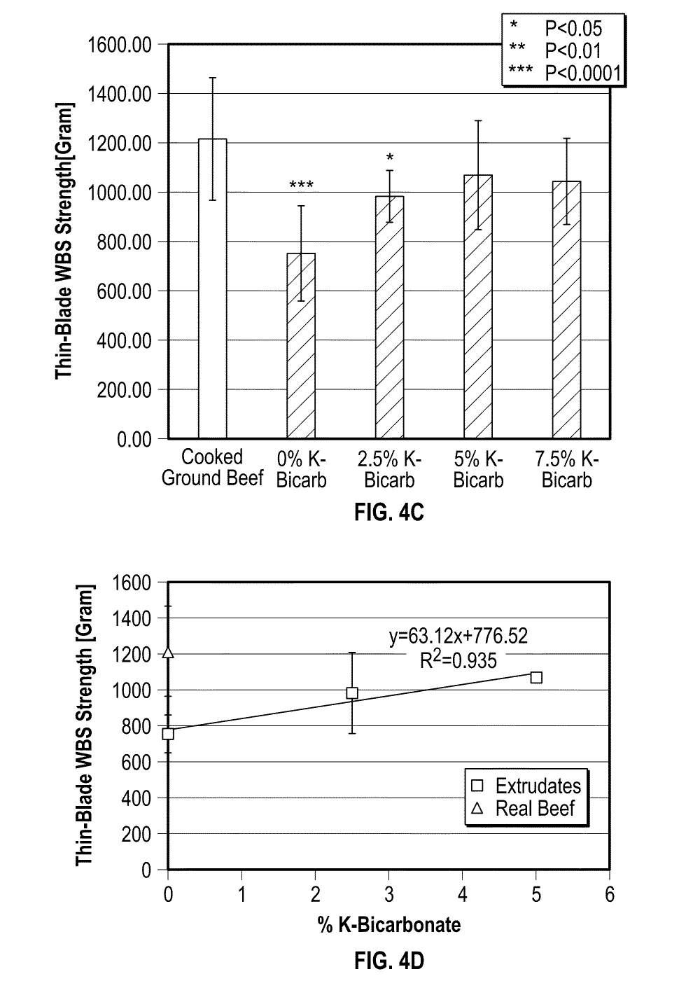

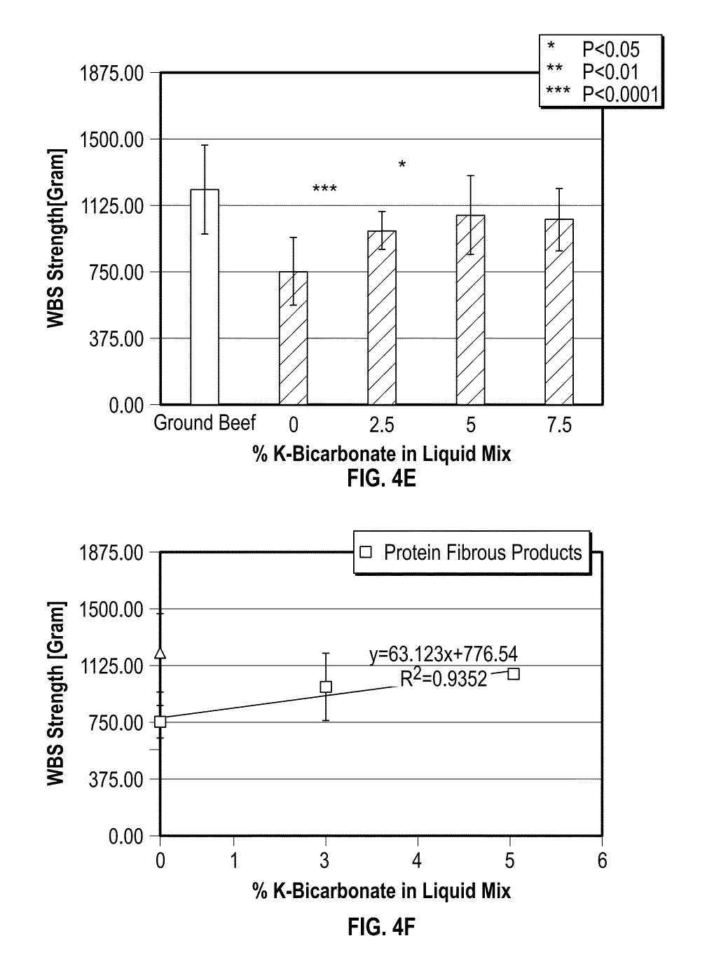

Intact samples of protein fibrous products that were 9 mm to 14 mm in diameter and that had minimal air pockets were selected and equilibrated by air drying at room temperature for 90 min. The samples were either used directly or hydrated as described above. Samples were placed on a standard WBS mount with a slit-space that allowed for clean, frictionless passage of a blade. Shear strength was measured with a a CT3 Texture Analyzer (Brookfield Engineering, Middleboro, Mass., USA) with a 10 kg capacity load cell and a 10 g trigger, using a 3.2 mm (thick) WBS fixture blade with a 60° V-shaped notch (width of V=47 mm; height of V=40 mm; radius at point of V=2.25 mm) run at a speed of 5 mm/sec, and allowing the blade to pass completely through the sample. The peak shear force was recorded, and the average WBS strength was calculated from 5 to 10 independent samples. As shown in FIGS. 4A and 4B, WBS strength was directly correlated with the pH of the protein fibrous products and hydrated protein fibrous products.

### Example 2

### Production of Meat Structured Protein Products by Thermoplastic Extrusion, and Characterization by Protein Structure, Moisture Content, Texture Profile, Water Holding Capacity, Water Activity, Percent Dissolved Solids, High Heat Hydration Integrity, and Sensory Analyses

Dry mixes of composition 95.4% by weight pea protein isolate (for details see footer of Table 1), 2% by weight of gypsum (for details see footer of Table 1), and 2.6% by weight of beef flavor (for details see footer of Table 1) were blended for 5 minutes in a ribbon blender. The dry ingredient blend was transferred to the hopper of a gravimetric feeder that metered the blend through the feed port of a twin screw extruder (MPF 50/25 Co-rotating Twin-Screw Extruder (APV Baker, Grand Rapids, Mich.) at a rate of 27.1 kg/h. At the same time, liquid mixes (water with potassium bicarbonate; see Table 4) were channeled from a water tank through an in-line water heater that kept the water temperature fixed at 21.1° C., and were pumped via a gear pump through the liquid feed port of the twin screw extruder (located 100 mm downstream of the dry mix feed port) at 22.8 kg/h. The pHs of the resulting doughs (Table 4) were measured by mixing 20 g of each dough with 75 g of water, and taking measurements with a pH meter calibrated with pH standards 1/7/10.

TABLE 4
Potassium Bicarbonate Levels in Liquid Mixes and pH of Doughs

| | K-Bicar- | Concen- | Concen- | |
|---|---|---|---|---|
| | bonate in | tration of | tration of | |
| | Liquid | K-Bicar- | K-Bicar- | |
| | Mix | bonate in | bonate in | pH of Dough ± |
| | (% by | Liquid Mix | Dough | Standard |
| Product | weight) | [moles/L] | [moles/L] | Deviation |
| 0% K-Bicar- | 0 | 0 | 0 | 6.8367 ± 0.0058 |
| bonate | | | | |
| 2.5% K-Bicar- | 2.5 | 0.172 | 0.071 | 7.0867 ± 0.0058 |
| bonate | | | | |
| 5% K-Bicar- | 5 | 0.345 | 0.141 | 7.1833 ± 0.0058 |
| bonate | | | | |
| 7.5% K-Bicar- | 7.5 | 0.517 | 0.212 | 7.2333 ± 0.0058 |
| bonate | | | | |
| 10% K-Bicar- | 10 | 0.689 | 0.283 | 7.32 ± 0.01 |
| bonate | | | | |
| 15% K-Bicar- | 15 | 1.034 | 0.424 | not determined |
| bonate | | | | |

Extrusion parameters were as shown in Table 5.

TABLE 5
Extrusion Parameters

| | |
|---|---|
| Screw Profile | Zones 1-3: conveying screw elements; Zones 4, 5: |
| Assembly | mixing screw elements; Zones 6-8: medium shear |
| | screws; Zone 9: final mixing screws. |
| Extruder Barrel | 10 zones, each individually controlled via an |
| | electric heater cartridge (4 × 900 W per zone) |
| | and a cooling water jacket (supplied with building |
| | water, 60° F.); |
| Barrel Heater Set | Zones 1-4: 30-35° C.; Zones 5-7: 55-91° C.; |
| Points | Zones 8-10: 111-125° C. |
| Extrusion Screws | Co-rotating in counter-clockwise direction at |
| | 200 revolutions per minute. |

Protein fibrous products (FIG. 1) emerged from the extruder as short, somewhat irregular, strands of crumbles, which were allowed to cool on a pan for 5 minutes. The composition of the pH adjusting agent comprising protein fibrous products was 42% by weight of protein, between 3.2% and 8.92% by weight of carbohydrate (0.53% by weight of edible fiber), 3.17% by weight of lipid, and between 43% and 48% by weight of water.

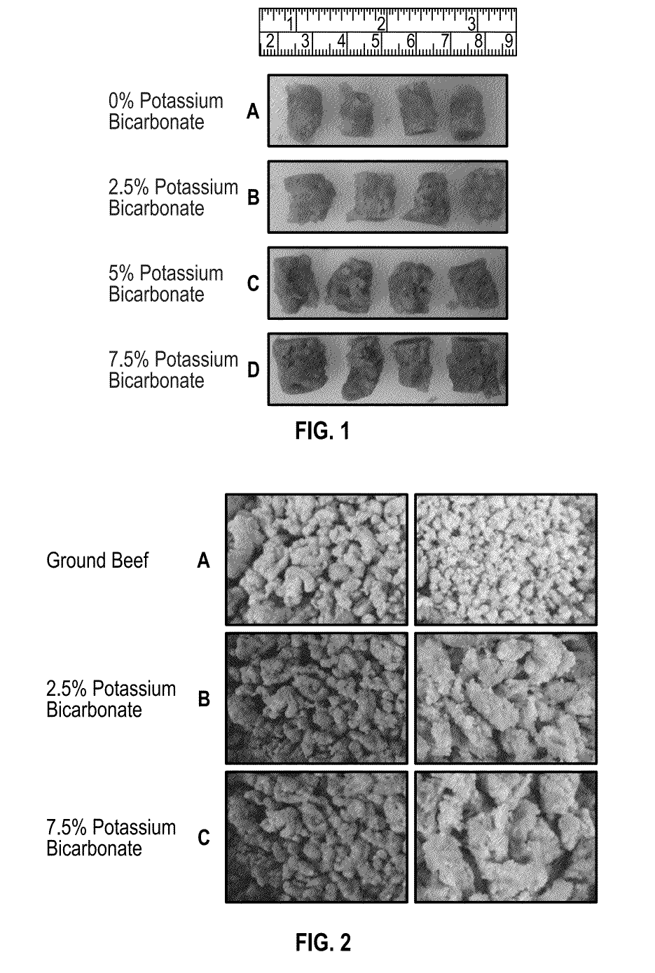

Hydrated protein fibrous products (FIG. 2) were obtained by mixing the protein fibrous products with an equal part by weight of 212° F. warm water and simmering in a covered vessel for 15 minutes (stirring every 3 minutes).

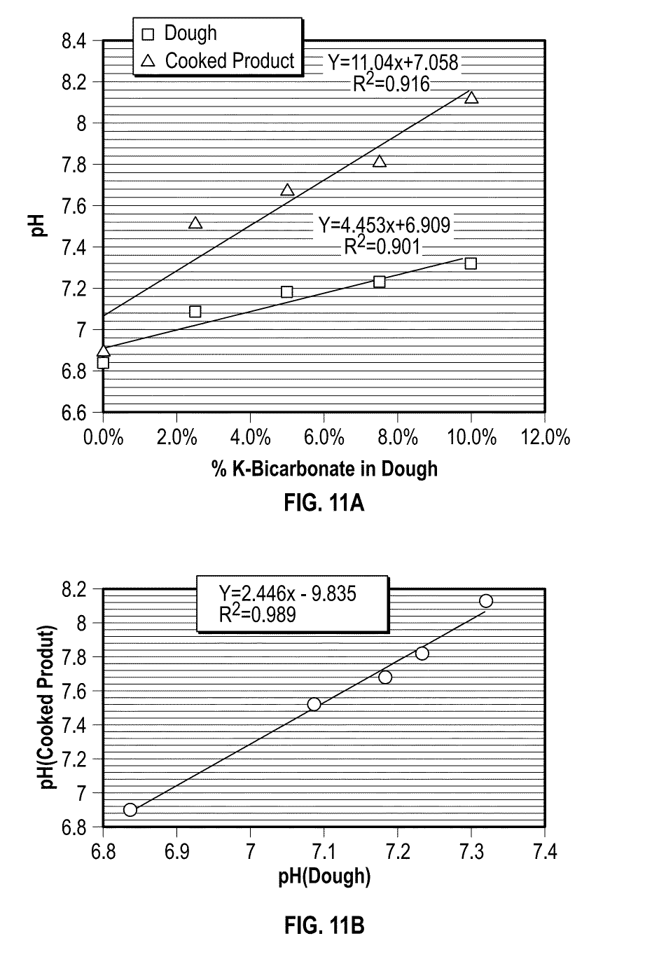

The pH of each product was measured by blending 20 g of each protein fibrous product with 75 g of water followed by recording pH using a pH meter calibrated with pH standards 2/7/10. As shown in FIG. 11, good correlations were observed between the amount of potassium bicarbonate in the dough, the pH of the doughs, and the pH of the protein fibrous products.

### Protein Structure Analysis

Protein fibrous products was analyzed directly whereas hydrated protein fibrous product was first washed thoroughly (to remove flavoring) 3 times by vortexing in PBS for 1 min followed by filtration of wash media (10 g product per 100 mL), and then dried in an evaporator to a moisture content of 40% to 50%. Each sample was fixed for 8-24 hours, then successively placed in a sucrose gradient (10% sucrose for 1 hour, 20% sucrose for 1 hour, 30% sucrose overnight), before being placed in OCT and frozen in isopentane. The OCT blocks were sliced on a microtome along either longitudinal or transversal axes, the slices were transferred to cold glass slides, and the sections were stained with PAS (Periodic Acid-Schiff) to identify polysaccharides and glycolipids, or with H&E (Hematoxylin & Eosin) to identify protein. The slices were imaged with a Nikon Eclipse E600 upright microscope with phase contrast, epifluorescence, and bright field capabilities (Nikon Corp., Japan) at 20× and 200× magnification to determine the presence of protein fiber networks similar to those present in animal meat. Interspersed open spaces were filled with polysaccharides and glycolipids. As shown in FIG. 3A, extrusion of a dough having pH 6.84 provided a gel-like protein structure with random fragmentation and punctuate granular structures. (Note that clear areas are due to freezing-induced fractures in the samples.) As shown in FIGS. 3B through 3E, extrusion of doughs having pH 7.32 led to the formation of protein fiber networks interspersed with open spaces filled with polysaccharides and glycolipids, structures that are more akin to the protein structure present in animal meat. Iodine staining and different freezing protocols (not shown here) revealed the presence of starches and water crystals, respectively, in the open spaces.

### Warner-Bratzler Shear (WBS) Analysis

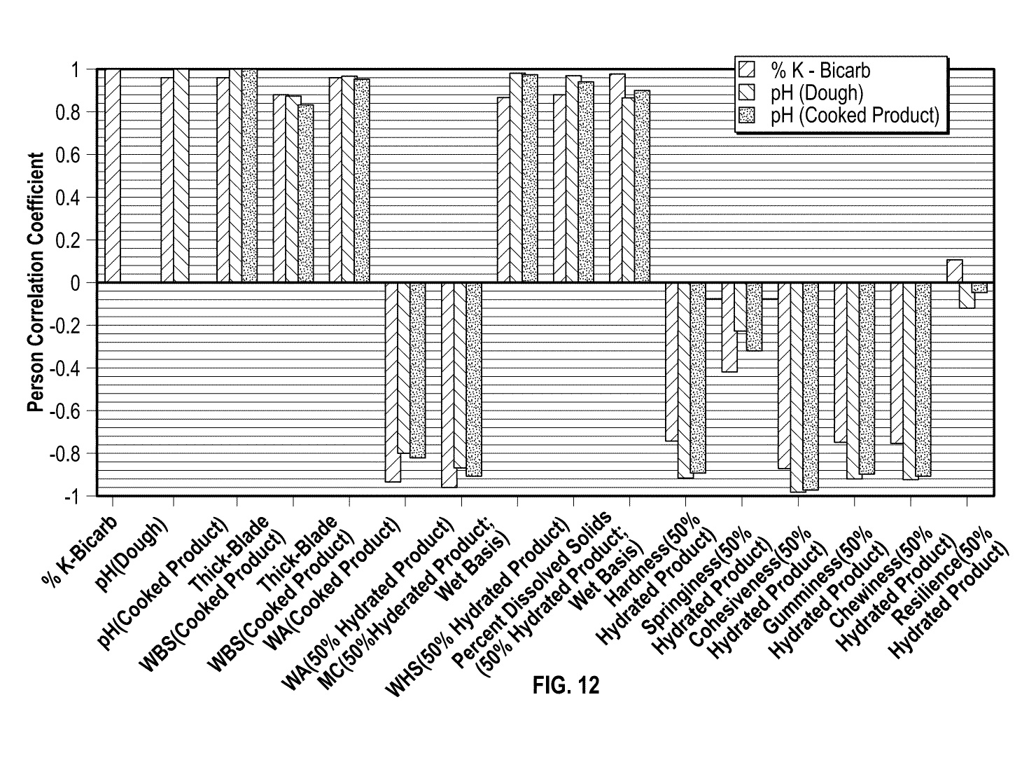

Crumbles 8 to 11 mm in diameter were selected from the fresh protein fibrous products and allowed to cool to room temperature. The protein fibrous products were either used directly or first hydrated. (Hydrated protein fibrous products can also be analyzed as protein fibrous products when they are first washed thoroughly (to remove flavoring) 3 times by vortexing the sample in PBS for 1 min followed by filtration of wash media (10 g product per 100 mL), and then dried in an evaporator to a moisture content of 40% to 50%.). WBS strengths of the meat structured protein products were compared to the WBS strength of cooked 80/20 ground beef. To this end, fresh 80/20 ground beef was purchased from HyVee (Columbia, Mo.), rolled into 8 to 11 mm diameter cylindrical shapes, and cooked to completeness. WBS strength was determined by placing each sample on a standard WBS mount with a slit-space that allowed for clean, frictionless passage of the blade, and by attaching either a 1 mm (thin) or a 3.2 mm (thick) WBS fixture blade with a 60° V-shaped notch (width of V=47 mm; height of V=40 mm; radius at point of V=2.25 mm) 100 kg capacity load cell on aTA.XT2 Texture Analyzer (Texture Technologies Corp., Scarsdale, N.Y.). The shear test speed was 1 mm/sec, and the blade was allowed to pass completely through the sample. The peak shear force was recorded. The average WBS shear strength for each product was derived from the analysis of 5 independent samples. As shown in FIGS. 4C through 4F, the WBS strength is directly correlated with the amount of potassium bicarbonate present in the dough, and approaches the WBS strength of cooked 80/20 ground beef at higher potassium bicarbonate levels. As shown in Table 6 and FIG. 12, good correlations were observed between the thin- and thick-blade WBS strengths of protein fibrous products and the amount of potassium bicarbonate in the dough, the pH of the dough, or the pH of the protein fibrous products.

### Texture Profile Analysis (TPA)

After cooling to room temperature, 26 g of crumbles 8 to 12 mm in diameter of each hydrated protein fibrous product were placed in an aluminum, circular pan of 7.62 cm diameter and with 1.27 cm high edges, forming a layer of material that was 8 to 12 mm in depth. TPA was done using a TA.XT2 Texture Analyzer (Texture Technologies Corp., Scarsdale, N.Y.) and an aluminum disc probe of 5.08 mm diameter (Texture Technologies, Hamilton, Mass.). The disc probe was used to compress each sample using a trigger force of 100 g to 50% compression in a 2-cycle analysis at a test speed of 1 mm/sec. The deformation curve of the sample was obtained, and from the deformation curve were derived the Force1, Force2, Area FT1:2, Time-diff 1:2, AreaFT1:3, AreaFT2:3, AreaFT4:6, and Time-diff4:5, according to the manufacturer's protocol. From this raw data, the mechanical characteristics were calculated as follows:

Springiness (i.e., ability of product to spring back after deformation during first compression)=(Time-diff4:5/Time-diff41:2);

Cohesiveness (i.e., ability of product to withstand a second deformation relative to how well it behaved under the first deformation)=(AreaFT4:6/AreaFT1:3);

Hardness (i.e., peak force of first compression of product)=Force2;

Gumminess=(Hardness×Cohesiveness);

Chewiness=(Springiness×Gumminess); and

Resilience (i.e., how well product “fights to regain its original shape”)=(Area FT2:3/Area FT1:2);

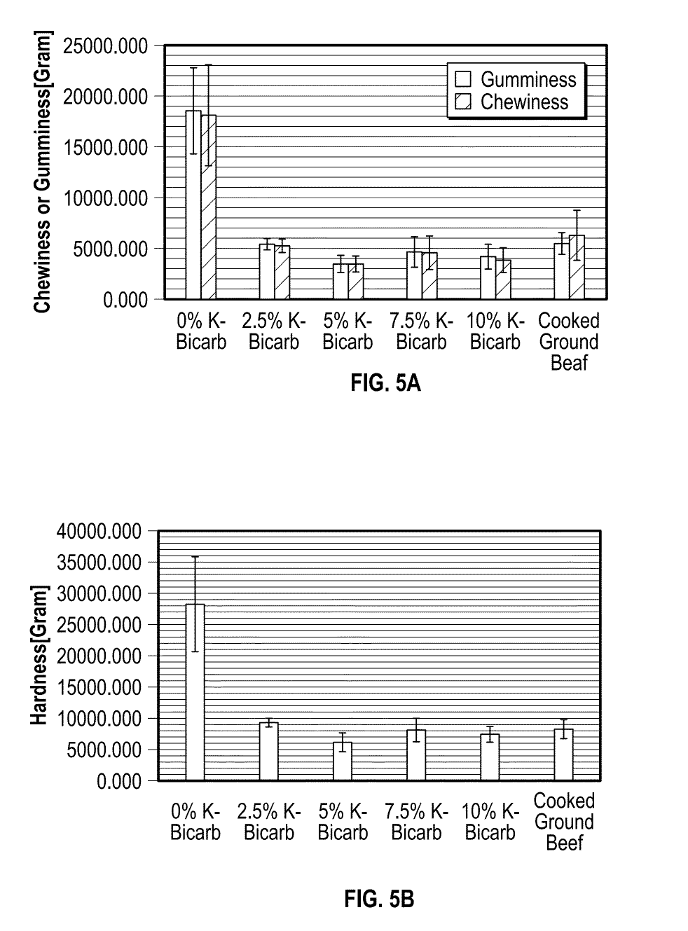

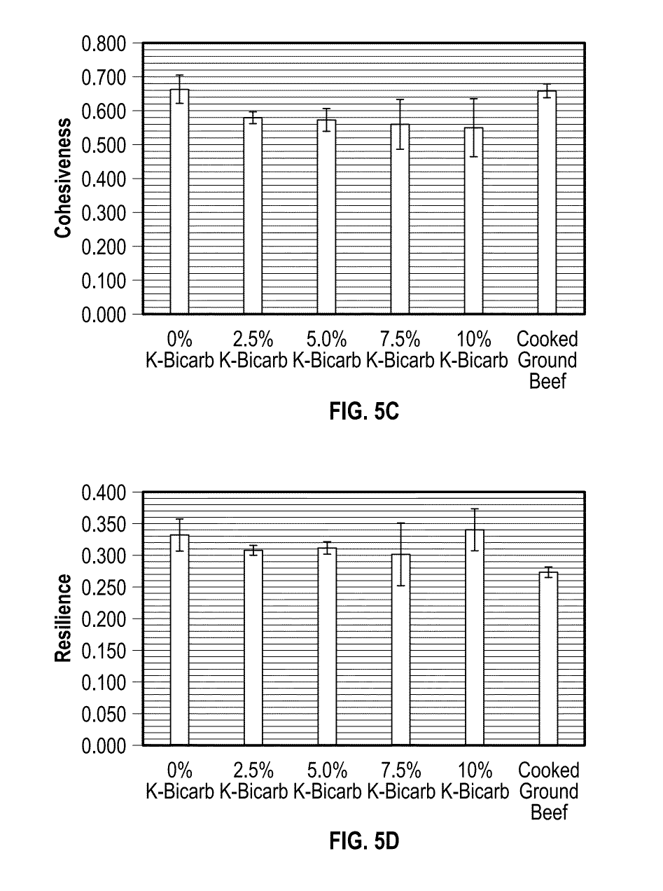

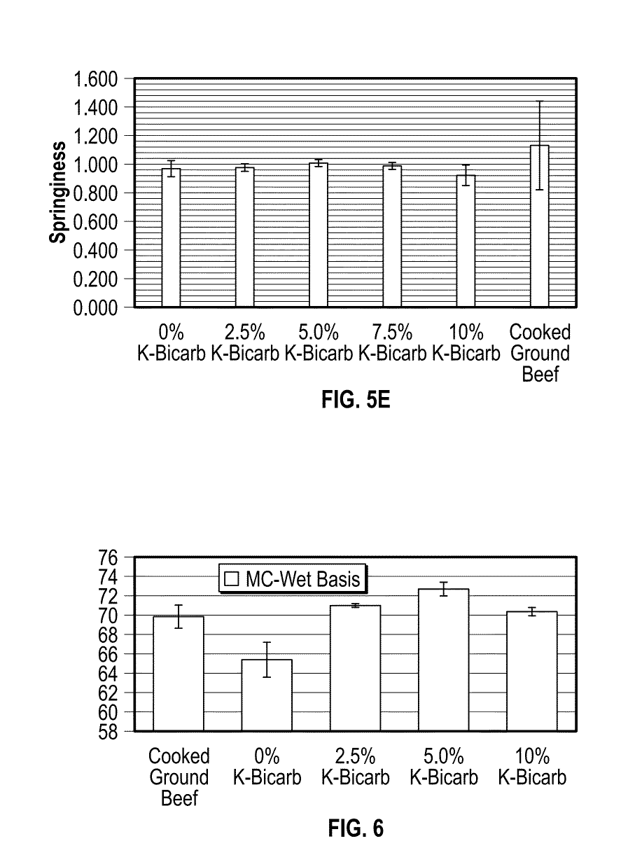

as described in Food Texture and Viscosity Second Edition: Concept and Measurement, Dr. Malcolm C. Bourne, April 2002, Academic Press, New York. Average measures were obtained from the analysis of 4 independent samples of each product. The mechanical properties of the meat structured protein products were compared to those of cooked 80/20 ground beef. The cooked 80/20 ground beef samples were prepared as described in Example 1 except that the cooked beef cylinders were broken into pieces of 1.5 cm length (similar to the lengths and sizes of the protein fibrous product samples), and 25 g samples were used for each analysis. As shown in FIG. 5, increasing the pH of the dough had a significant effect on the mechanical characteristics of the meat structured protein products, and made the mechanical characteristics of the meat structured protein products more closely approximate those of cooked ground beef. As shown in Table 6 and FIG. 12, good correlations were observed between the mechanical characteristics of the meat structured protein products.

### Moisture Content (MC) Analysis

Approximately 2 g sample of each hydrated protein fibrous product was blended in a blender for 30 seconds. The sample was weighed in a dried aluminum pan, heated in an oven for 16 hours at 103° C., and reweighed after heating. MC was calculated by dividing the mass of the moisture lost during heating by the total mass of the product prior to heating. Average MC was calculated from 3 independent samples. As shown in FIG. 6, the meat structured protein products had comparably high MC. As shown in Table 6 and FIG. 12, good correlations were observed between the MC of hydrated protein fibrous product and the amount of potassium bicarbonate in the dough, the pH of the dough, or the pH of the protein fibrous product.

### Water Holding Capacity (WHC) Analysis

In a 50 mL centrifuge tube, a 3 g sample of each hydrated protein fibrous product was combined with 10 mL distilled water, the mixture was agitated using a vortexer at low speed for 30 seconds, and then incubated for 60 minutes at room temperature (25° C.). The mixture was then centrifuged at 5,000 rpm for 30 minutes, the supernatant was decanted into pre-weighed, 125 mL Erlenmeyer flasks, and the pellet was weighed in the 50 mL centrifuge tube. The residual water in the 50 mL centrifuge tube was adjusted for by calculating residual water in 10 mL distilled water blanks. Supernatants were dried overnight at 100° C., then cooled and weighed to determine the amount of solids not included in the pellet weight. Variables such as pellet weight, water retained by blank, and decantated solids weight were determined by subtracting the final weight from the initial weight. WHC was calculated according to the following formula:

[((sample weight after hydration−dry sample weight)/(sample weight after hydration))×100].

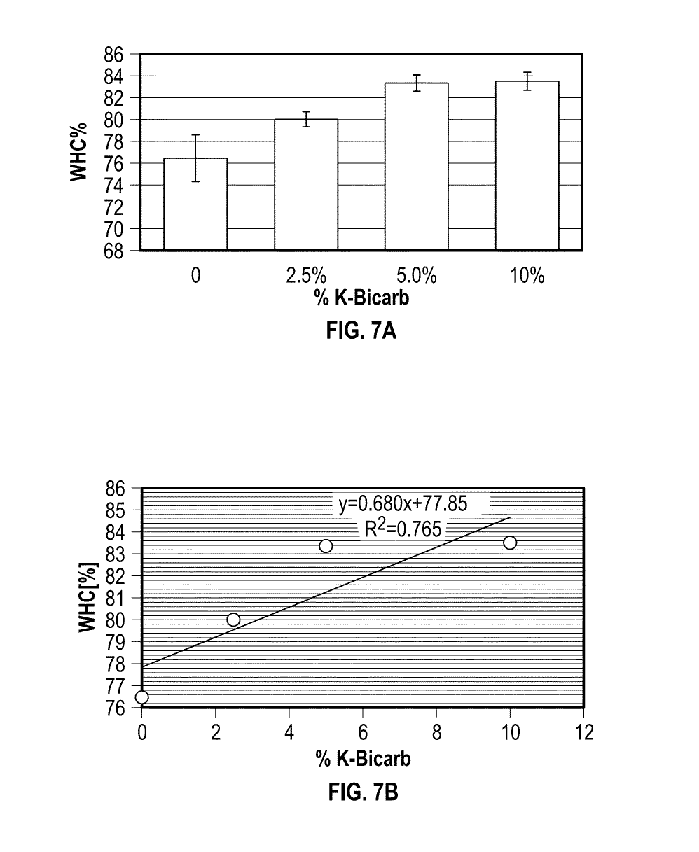

The average WHC for each product was derived from the analysis of 4 independent samples. As shown in FIG. 7, the WHC was directly correlated with the pH of the dough. As shown in Table 6 and FIG. 12, good correlations were observed between the WHC of hydrated protein fibrous products and the amount of potassium bicarbonate in the dough, the pH of the dough, or the pH of the protein fibrous product. Without being bound by theory, it is possible that the pH adjusting agent allows the meat structured protein product to expand slightly upon exiting from the cooling die, which may create more open spaces in the final meat structured protein product for imbibing water upon hydration. It is equally possible that the inclusion of the pH adjusting agent leads to the creation of more hydrophilic regions within the protein structure, or that it leads to an increase in hydrogen bonding interactions for take-up of water before and after extrusion.

### Water Activity (WA) Analysis

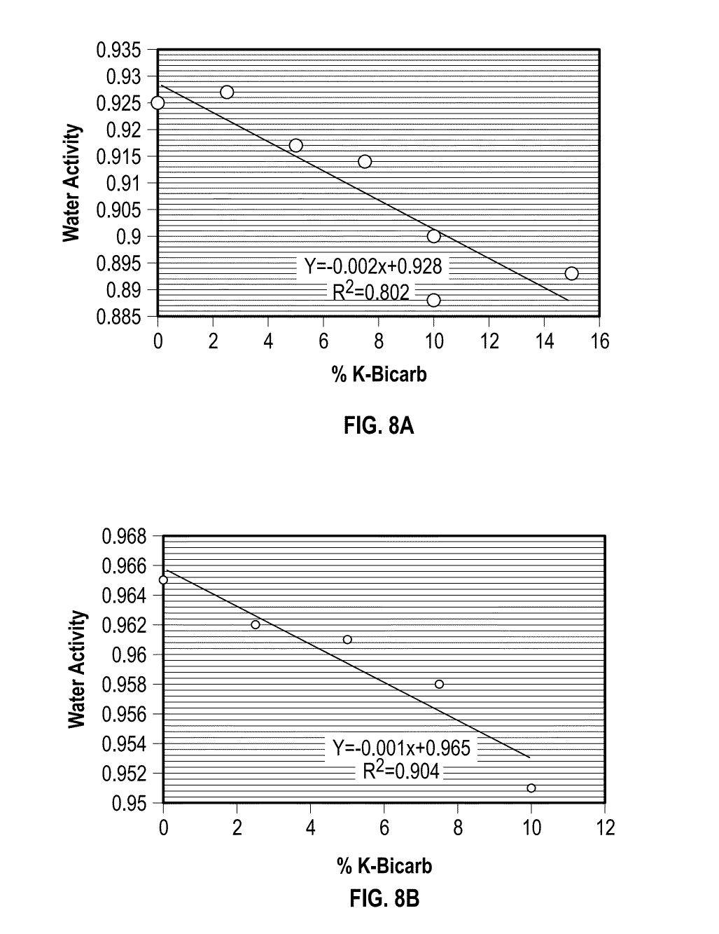

The WAs were determined using a AquaLab CX-2 water activity meter (Decagon Devices, Inc., Pullman, Wash.). Approximately 1 to 2 g of each sample was shredded into 5 to 10 randomly sized pieces. Chilled mirror dew-point technology was used to measure vapor pressure. WA is the ratio between the vapor pressure of a sample itself when in a completely undisturbed balance with the surrounding air media and the vapor pressure of distilled water under identical conditions. A WA of 0.80 means the vapor pressure is 80% of that of pure water. The average WA for each product was derived from the analysis of 3 independent samples. As shown in FIG. 8, the WA is inversely correlated with the pH of the dough. As shown in Table 6 and FIG. 12, good correlations were observed between the WA of protein fibrous products or hydrated protein fibrous products and the amount of potassium bicarbonate in the dough, the pH of the dough, or the pH of the protein fibrous product. Without being bound by theory, inclusion of the pH adjusting agents in the dough may change the meat structured protein product in a manner that better permits trapping of water.

### Percent Dissolved Solids (PDS) Analysis

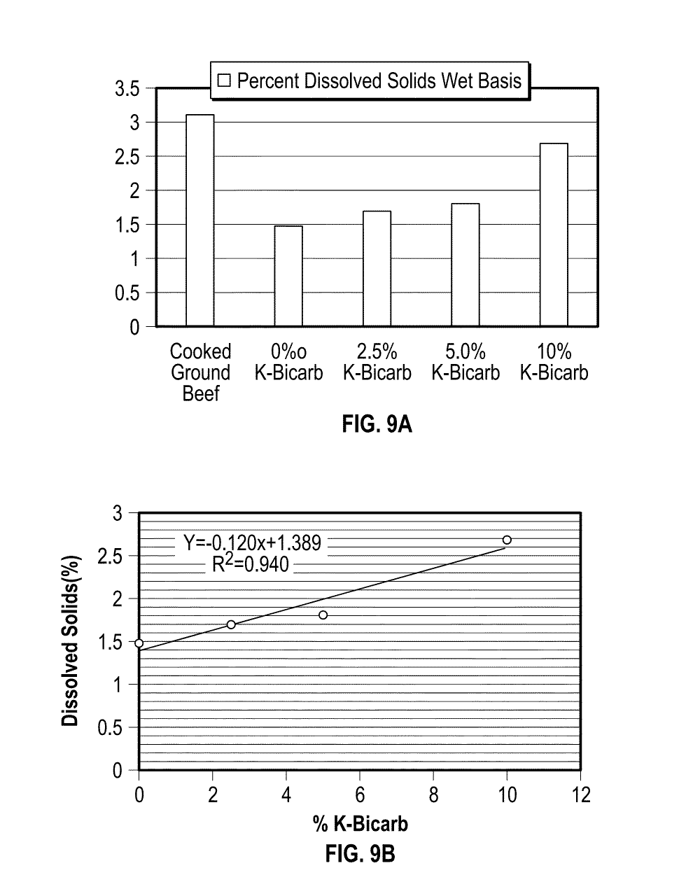

A sample of each hydrated protein fibrous product was combined with water at 3.85% (w/v), the slurry was shaken for 1.5 hours at 150 rpm, and then centrifuged for 30 minutes at 5,000 rpm followed by 30 minutes at 9,000 rpm to precipitate fine particles. Protein content of the supernatants was determined spectrophotometrically. Experimental samples were diluted within the range of the standard curve, and buffer concentrations were sufficiently diluted to not interfere with the assay. Controls were diluted 1:10 (v/v) with distilled water. Standard curve samples were adjusted to the same buffer concentration as experimental samples. The average PDS for each product was derived from the analysis of 4 independent samples. As shown in FIG. 9, the PDS of the hydrated protein fibrous products is directly correlated with the pH of the dough, and approaches the PDS of cooked ground beef at high pH. As shown in Table 6 and FIG. 12, good correlations were observed between the PDS of hydrated protein fibrous products and the amount of potassium bicarbonate in the doughs, the pH of the doughs, or the pH of the protein fibrous products.

### High Heat Hydration Integrity (HHHI) Analysis

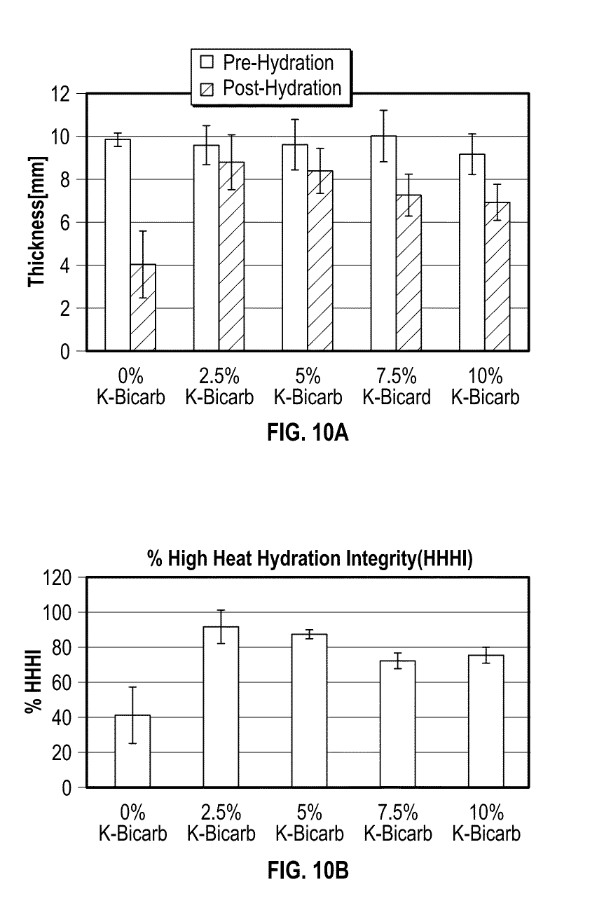

HHHI was analyzed by determining pre- and post-hydration product sizes of the meat structured protein products. To this end, 1 kg of each protein fibrous product was mixed with 1 L of water with a ribbon mixer at 10 rpm for 30 minutes while simmering (100° C.). The sample was subsequently cooled to ambient temperature (25° C.) and measured with the Texture Analyzer for product height. The HHHI was calculated as the percentage of the size of the hydrated protein fibrous product relative to the size of the starting material (i.e., protein fibrous product). The average HHHI for each product was derived from the analysis of 6 independent samples. As shown in FIG. 10, the HHHI of the meat structured protein products was significantly increased at higher pH of the dough.

TABLE 6
Pearson Correlation Coefficients of Potassium Bicarbonate
Content in Dough, pH of Dough and Protein Fibrous Product,
and Characteristics of Meat Structured Protein Products

| | | | pH (Protein |
|---|---|---|---|
| | | | Fibrous |
| | % K-Bicarb | pH (Dough) | Product) |
| % K-Bicarb | 1 | | |
| pH (Dough) | 0.949369472 | 1 | |
| pH (Protein Fibrous | 0.957087935 | 0.994738203 | 1 |
| Product) | | | |
| WA (Protein Fibrous | −0.927675101 | −0.793062697 | −0.819545646 |
| Product | | | |
| WA (Hydrated Protein | −0.951101277 | −0.864422602 | −0.902866735 |
| FibrousProduct) | | | |
| MC (wet basis) | 0.860015179 | 0.972817444 | 0.967967547 |
| WHC | 0.874711375 | 0.962737247 | 0.933899804 |
| Percent dissolved | 0.970018735 | 0.858762257 | 0.89388545 |
| solids (wet basis) | | | |
| Hardness | −0.731915945 | −0.908539532 | −0.883289197 |
| Springiness | −0.405882867 | −0.218632667 | −0.312871117 |
| Cohesiveness | −0.861354533 | −0.973427312 | −0.963934914 |
| Gumminess | −0.734939772 | −0.910418235 | −0.886271165 |
| Chewiness | −0.743626628 | −0.91586009 | −0.893592151 |
| Resilience | 0.099067705 | −0.118358901 | −0.04247476 |

### Sensory Analysis

Textural characteristics of the 10% K-bicarbonate product formed into burger patties as described in Example 2 were determined by SCS Global Services (Emeryville, Calif.). The patties were evaluated and compared to 80/20 ground beef burger purchased at Safeway. The samples were cooked on an electric skillet at 325° F. until an internal temperature of 160° F. was reached. The samples were then evaluated by a panel of trained sensory experts using a scorecard for aroma, flavor, appearance, and texture. As shown in Table 7, the 10% K-bicarbonate product was scored similar to 80/20 ground beef burger for “moistness” and “hardness/firmness”, and higher for “overall texture”. Comments by panelists and analysts included “moist texture”, “very consistent/uniform”, and “great texture”.

TABLE 7
Textural Characteristics as Judged by Expert Sensory Panel

| | 10% K-Bicarbonate | Cooked 80/20 |
|---|---|---|
| | Product | Ground Beef |
| Moistness | 3.2 | 3.9 |
| Hardness/Firmness | 6.6 | 6.9 |
| Overall Texture | 7.2 | 6.4 |

### Example 3

### Production of Meat Structured Protein Products by Thermoplastic Extrusion, and Characterization by Urea Analysis

Protein fibrous products and hydrated protein fibrous products were produced essentially as described in Example 1 using a dry mix that comprised either 0% by weight of potassium bicarbonate (see Table 1 for composition of dry mix) or 4% by weight of potassium bicarbonate (composition of dry mix: 93.5% pea protein isolate F85M, 2.5% beef flavor, and 4% potassium bicarbonate).

### Urea Analysis

Five 25 g samples of each protein fibrous product and each hydrated protein fibrous product were washed with 100 mL of PBS before they were soaked for 1 hour at room temperature in 100 mL of either PBS or 10 mM dithiothreitol (DTT) or 8M urea on a rocker table. The samples were recovered from the PBS, dTT, and urea by decanting off the solvent and placing the solids onto a paper towel. Average sample diameters were measured using calipers.

The samples were then placed on a 1 mm metal mesh and rinsed with 1 L of PBS. The samples were placed on a paper towel and dry blotted, and finally weighed. As shown in Table 8, meat structured protein products produced from a dough that had a pH of more than 7.05 were stable in urea whereas products produced from a dough that had a pH of less than 7 were not stable in urea (all samples were stable in PBS and DTT).

TABLE 8
Urea Analysis of Protein Fibrous Products
and Hydrated Protein Fibrous Products

| Product | PBS | 10 mM DTT | 8M Urea |
|---|---|---|---|
| | Percent Size Change Relative to Starting Sample | | |
| 0% K-Bicar- | <25 | <25 | >90 |
| bonate | | | |
| 4% K-Bicar- | <25 | <25 | <50 |
| bonate | | | |
| | Percent Material Left in Filter Relative to Starting Sample | | |
| 0% K-Bicar- | >90 | >75 | <25 |
| bonate | | | |
| 4% K-Bicar- | >75 | >75 | >65 |
| bonate | | | |

### Example 4

### Flavoring, Forming, and Cooking of Patties Comprising Meat Structured Protein Product

The hydrated protein fibrous products generated in Example 2 were first frozen and then further processed as follows (all percentages are % of the final mix):

a) The frozen crumbles (62.5%) were mixed in a chilled tabletop mixer with the binding agents carageenan (0.4%) and methylcellulose (1.7%).
b) Chilled water (17.5%) and sorbitol (2.9%) were added to the mixture and mixed until the binders were fully hydrated.
c) Flavoring agents, spices, and DHA oils were added to the mixture and mixed until fully incorporated and evenly dispersed.
d) The mix was portioned and formed into 100 g patties.

The patties were placed on a lightly oiled pan, covered, and baked in a 325° F. convection oven for 13 minutes, flipped over and baked for an additional 5 minutes.

What is claimed:

1. A meat structured protein product, wherein the meat structured protein product has an alkaline pH of at least 7.05 and a moisture content of at least 30% by weight and wherein such meat structured protein product, further, comprises
a) protein fibers that are substantially aligned; and
b) at least 5% by weight of a non-animal protein material.

2. A meat structured protein product of claim 1 which has an alkaline pH of between 7.4 and about 10.0.

3. A meat structured protein product of claim 1 which has an alkaline pH of between about 8.25 and about 8.75.

4. A meat structured protein product of claim 1 which is a protein fibrous product.

5. A protein fibrous product of claim 4 which comprises between about 20% and about 80% by weight of a non-animal protein material.

6. A protein fibrous product of claim 4 which comprises between about 30% and about 50% by weight of a non-animal protein material.

7. A protein fibrous product of claim 4 which further comprises between about 1% and about 10% by weight of lipid.

8. A protein fibrous product of claim 4 which further comprises between about 2% and about 5% by weight of lipid.

9. A protein fibrous product of claim 4 which further comprises between about 1% and about 20% by weight of carbohydrate.

10. A protein fibrous product of claim 4 which further comprises between about 2% and about 4% by weight of carbohydrate.

11. A protein fibrous product of claim 7 wherein the carbohydrate component comprises edible fiber that is in the range of between about 0.1% and about 1% by weight of the protein fibrous product.

12. A protein fibrous product of claim 4 which has a moisture content between about 30% and about 70% by weight.

13. A protein fibrous product of claim 4 which has a moisture content between about 40% and about 60% by weight.

14. A protein fibrous product of claim 4 which has an alkaline pH of between about 8.25 and about 8.75, a moisture content between about 40% and about 60% by weight and which comprises between about 30% and about 50% by weight of a non-animal protein material, between about 2% and about 5% by weight of lipid, between about 2% and about 4% by weight of carbohydrate wherein such carbohydrate component comprises edible fiber that is in the range of between about 0.1% and about 1% by weight of the protein fibrous product.

15. A meat structured protein product of claim 1 which is a hydrated protein fibrous product.

16. A hydrated protein fibrous product of claim 15 which comprises between about 5% and about 45% by weight of a non-animal protein material.

17. A hydrated protein fibrous product of claim 15 which comprises between about 10% and about 25% by weight of a non-animal protein material.

18. A hydrated protein fibrous product of claim 15 which further comprises between about 0.5% and about 5% by weight of lipid.

19. A hydrated protein fibrous product of claim 15 which further comprises between about 1% and about 3% by weight of lipid.

20. A hydrated protein fibrous product of claim 15 which further comprises between about 0.5% and about 10% by weight of carbohydrate.

21. A hydrated protein fibrous product of claim 15 which further comprises between about 1% and about 3% by weight of carbohydrate.

22. A hydrated protein fibrous product of claim 20 wherein the carbohydrate component comprises edible fiber that is in the range of between about 0.05% and about 1% by weight of the hydrated protein fibrous product.

23. A hydrated protein fibrous product of claim 15 which has a moisture content between about 50% and about 85% by weight.

24. A hydrated protein fibrous product of claim 15 which has a moisture content between about 70% and about 80% by weight.

25. A hydrated protein fibrous product of claim 15 which has an alkaline pH of between about 8.25 and about 8.75, a moisture content between about 70% and about 80% by weight and which comprises between about 10% and about 25% by weight of a non-animal protein material, between about 1% and about 3% by weight of lipid, between about 1% and about 3% by weight of carbohydrate wherein the carbohydrate component comprises edible fiber that is in the range of between about 0.05% and about 1% by weight of the hydrated protein fibrous product.

26. An extended meat product, wherein the extended meat product comprises less than about 20% of an animal meat and at least about 70% of a meat structured protein product as claimed in claim 1.

27. An extended meat product, wherein the extended meat product comprises at least about 50% of an animal meat and less than about 50% of a meat structured protein product as claimed in claim 1.

28. A process for producing a meat structured protein product comprising protein fibers that are substantially aligned, wherein the process comprises:
a) combining a non-animal protein material and water with a pH adjusting agent to form a dough which has an alkaline pH of at least 7.05;
b) shearing and heating the dough so as to denature the proteins in the protein material and produce protein fibers that are substantially aligned in a fibrous structure; and
c) setting the dough to fix the fibrous structure previously obtained, thereby obtaining a meat structured protein product having a moisture content of at least 30% by weight and comprising at least 5% by weight of a non-animal protein material.

29. A process of claim 28 wherein the meat structured protein product produced is a protein fibrous product.

30. A process of claim 29 wherein the protein fibrous product produced has an alkaline pH of between about 8.25 and about 8.75, a moisture content of between about 40% and about 60% by weight and which comprises between about 30% and about 50% by weight of a non-animal protein material, between about 2% and about 5% by weight of lipid, between about 2% and about 4% by weight of carbohydrate wherein such carbohydrate component comprises edible fiber that is in the range of between about 0.1% and about 1% by weight of the protein fibrous product.

31. A process of claim 28 which further comprises the step of subjecting the meat structured protein product produced by setting the dough to fix the fibrous structure to post-processing.

32. A process of claim 28 wherein the meat structured protein product produced is a hydrated protein fibrous product.

33. A process of claim 32 wherein the hydrated protein fibrous product produced has an alkaline pH of between about 8.25 and about 8.75, a moisture content of between about 70% and about 80% by weight and which comprises between about 10% and about 25% by weight of a non-animal protein material, between about 1% and about 3% by weight of lipid, between about 1% and about 3% by weight of carbohydrate wherein the carbohydrate component comprises edible fiber that is in the range of between about 0.05% and about 1% by weight of the hydrated protein fibrous product.
